(19) United States
(12) Patent Application Publication
(10) Pub. No.: US 2025/0378387 A1
(43) Pub. Date: Dec. 11, 2025

(54) ANOMALY DETECTION IN AN EDGE DEVICE INTEGRATED WITH A DATA INTAKE SYSTEM

(71) Applicant: Cisco Technology, Inc., San Jose, CA (US)

(72) Inventors: William Huang, Vaughan (CA); Joel Jacob, Etobicoke (CA); Yow Han Moo, Milpitas, CA (US); Rodrigo Paulo Quaresma, Burlington (CA); Alan Sung, Richmond Hill (CA)

(21) Appl. No.: 19/234,998

(22) Filed: Jun. 11, 2025

Related U.S. Application Data
(60) Provisional application No. 63/658,655, filed on Jun. 11, 2024.

(51) Int. Cl. G06N 20/00

(52) U.S. Cl. CPC G06N 20/00

(57) ABSTRACT

Techniques for detecting anomalies at an edge device integrated with a data intake system are disclosed. Sensor data captured by a set of edge devices is received at a system. The system is remote from the set of edge devices. A subset of the sensor data is selected based on a query. The machine learning model is trained to detect anomalies using the subset of the sensor data. After training the machine learning model, the machine learning model is deployed on the edge device. The machine learning model is executed at the edge device to detect one or more anomalies based on runtime sensor data captured at the edge device.

### BACKGROUND

Information technology (IT) environments can include diverse types of data systems that store large amounts of diverse data types generated by numerous devices. For example, a large data ecosystem may include databases such as MySQL and Oracle databases, cloud computing services such as Amazon web services (AWS), and other data systems that store passively or actively generated data, including machine-generated data (“machine data”). The machine data can include log data, performance data, diagnostic data, metrics, tracing data, or any other data that can be analyzed to diagnose equipment performance problems, monitor user interactions, and to derive other insights.

The large amount and diversity of data systems containing structured, semi-structured, and unstructured data relevant to any search query can be massive, and continues to grow rapidly. This technological evolution can give rise to various challenges in relation to collecting, managing, understanding, and effectively utilizing the data. To reduce the potentially vast amount of data that may be generated, some data systems pre-process data based on anticipated data analysis needs. In particular, specified data items may be extracted from the generated data and stored in a data system to facilitate efficient retrieval and analysis of those data items at a later time. At least some of the remainder of the generated data is typically discarded during pre-processing. Collecting and storing massive quantities of minimally processed or unprocessed data for later retrieval and analysis is becoming increasingly more feasible as new techniques are developed.

### BRIEF DESCRIPTION OF THE DRAWINGS

Illustrative examples are described in detail below with reference to the following figures:

FIG. 1 illustrates a block diagram of an example data processing environment.

FIG. 2 illustrates a block diagram of an example data processing environment.

FIG. 3 illustrates a block diagram of an example data source.

FIGS. 4A-4C illustrate block diagrams of an example edge device.

FIG. 5 illustrates a block diagram of an example edge device within a data processing environment.

FIG. 6 illustrates a flowchart of an example process for detecting anomalies at an edge device.

FIG. 7 is a block diagram illustrating an example computing environment that includes a data intake and query system.

FIG. 8 is a block diagram illustrating in greater detail an example of an indexing system of a data intake and query system.

FIG. 9 is a block diagram illustrating in greater detail an example of a search system of a data intake and query system.

### DETAILED DESCRIPTION

Modern data centers and other computing environments can comprise anywhere from a few host computer systems to thousands of systems configured to process data, service requests from remote clients, and perform numerous other computational tasks. During operation, various components within these computing environments often generate significant volumes of machine data. Machine data is any data produced by a machine or component in an information technology (IT) environment that reflects activity in the IT environment. For example, machine data can be raw machine data that is generated by various components in IT environments, such as servers, sensors, routers, mobile devices, Internet of Things (IoT) devices, etc. Machine data can include system logs, network packet data, sensor data, application program data, error logs, stack traces, system performance data, etc. In general, machine data can also include performance data, diagnostic information, and many other types of data that can be analyzed to diagnose performance problems, monitor user interactions, and to derive other insights.

A number of techniques are used to collect and analyze machine data. For example, edge devices coupled with sensors can be deployed within the IT environment to collect machine data and send the machine data to a data intake and query system. In such configurations, the edge devices and sensors function as data sources for the data intake and query system. The system may then parse the machine data to produce events each having a portion of machine data associated with a timestamp, and then store the events. The system enables users to run queries against the stored events to, for example, retrieve events that meet filter criteria specified in a query, such as criteria indicating certain keywords or having specific values in defined fields. Additional query terms can further process the event data, such as, by transforming the data, etc.

At the edge device, typically a number of services are run to manage the movement of the machine data as it is captured by the sensors and is transmitted by the edge device to the data intake and query system. In some instances, the services may communicate with each other as well as with the sensors using a particular messaging protocol. In some cases, sensors and/or services can communicate using one or more conventional messaging protocols. In other cases, sensors and/or services can communicate using proprietary messaging protocols and/or messaging procedures developed for the edge device to enable efficient delivery of data to a data intake and query system. Some such messaging procedures and messaging protocols are described in U.S. patent application Ser. No. 17/733,176, titled “Messaging Procedure at Edge Device for Delivery of Data to Intake System,” filed on Apr. 29, 2022, which is incorporated herein in its entirety. For example, the edge device may include a system memory that has instructions stored therein for executing a message broker and a set of services. The message broker provides communication between a number of clients, which include the services running on the edge device as well as one or more sensors coupled to the edge device. The message broker may implement a topic-based publish-subscribe protocol in which messages are published by clients to certain topics and published messages are delivered to the clients that are subscribed to those topics. Each client may subscribe to one or more of the topics and the message broker may track these subscriptions by maintaining and updating a list of subscriptions. In some examples, the Message Queuing Telemetry Transport (MQTT) protocol is used to implement message brokers described herein.

In some examples, a configuration file that contains configuration data may be loaded onto the edge device after it is received from an external sender. The configuration data, which may be unpackaged by a data streamer service running on the edge device, may indicate which topics the data streamer service is to subscribe to and may further provide other instructions for modifying the operation of other services and sensors. In one example, the configuration data may include a request for anomaly data associated with a particular type of sensor data, and accordingly the data streamer service may subscribe to a topic for detected anomalies and an anomaly detection service may subscribe to a topic for that particular type of sensor data. Thereafter, the data streamer service may begin receiving published messages from the anomaly detection service that indicate whether an anomaly has been detected.

In some cases, the anomaly detection service running on the edge device is based on one or more machine learning models. Presently, some implementations of the edge device can support local machine learning using the resources of the edge device itself. For example, the edge device is used to train and run one or more machine learning models based on training datasets stored on the edge device. Such local machine learning can be limited by several factors, including relatively small memory and processing resources, which can constrain the sizes of training data sets and models and result in lower quality models and longer runtimes and/or latencies. Further, such local machine learning has tended to run in an autonomous fashion (unsupervised learning) and to otherwise provide limited user involvement capability. Novel approaches to machine learning in an edge device are presented herein. The approaches generally seek to address a spectrum of use cases. At one end of the spectrum are users that have data to use as a training dataset, but do not have their own machine learning models and may have limited machine learning knowledge. For such users, some embodiments use a machine learning deployment system to provide an environment and architecture in which such users can select and load training data to train a machine learning model, verify whether the model is running properly (i.e., providing expected anomaly detection results), and either tweak parameters of the machine learning model or push the model to the edge device. At the other end of the spectrum are users that already have their own trained machine learning models and want to run those models on the edge device. For such users, some embodiments provide a board support package that enables a neural processing unit (NPU) on the edge device to run the user-supplied models.

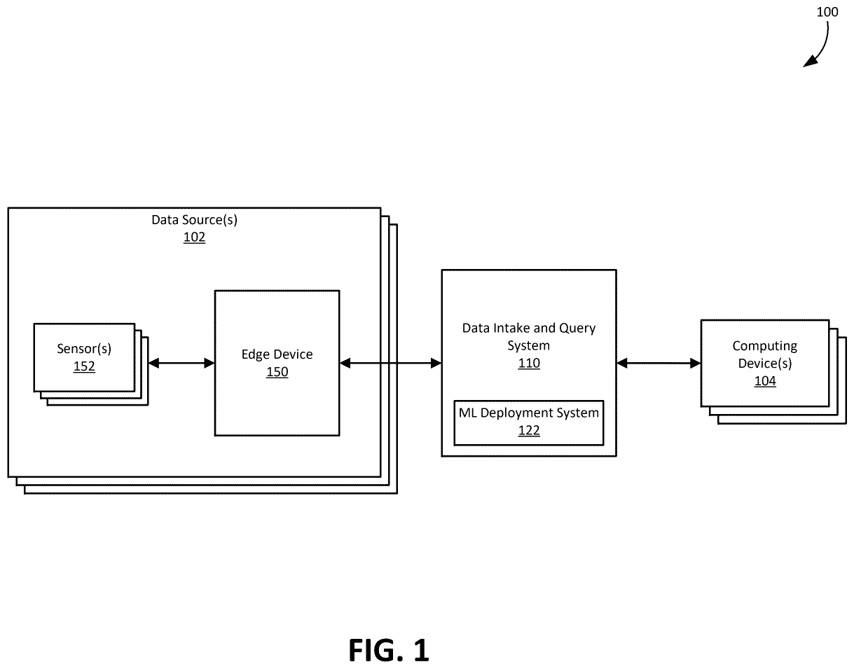

FIG. 1 illustrates a block diagram of an example data processing environment 100, according to some embodiments. In the illustrated example, data processing environment 100 includes one or more data sources 102, a data intake and query system 110, and one or more computing devices 104 (alternatively referred to as “client devices” or “client computing devices”). Each of data sources 102 may include an edge device 150 that is communicatively coupled with one or more sensors 152. In some examples, data processing environment 100 may be alternatively referred to as a “computing environment”.

Data intake and query system 110, edge devices 150, and computing devices 104 can communicate with each other via one or more networks, such as a local area network (LAN), wide area network (WAN), private or personal network, cellular networks, intranetworks, and/or internetworks using any of wired, wireless, terrestrial microwave, satellite links, etc., and may include the Internet. Although not explicitly shown in FIG. 1, it will be understood that one or more of computing devices 104 can communicate with edge device 150 via one or more networks. For example, if edge device 150 is configured as a web server and computing device 104 is a laptop, the laptop can communicate with the web server to view a website.

Computing devices 104 can correspond to distinct computing devices that can configure, manage, or sends queries to system 110. Examples of computing devices 104 may include, without limitation, smart phones, tablet computers, handheld computers, wearable devices, laptop computers, desktop computers, servers, portable media players, gaming devices, or other device that includes computer hardware (e.g., processors, non-transitory computer-readable media, etc.) and so forth. In certain cases, computing devices 104 can include a hosted, virtualized, or containerized device, such as an isolated execution environment, that shares computing resources (e.g., processor, memory, etc.) of a particular machine with other isolated execution environments.

Computing devices 104 can interact with system 110 and/or edge devices 150 in a variety of ways. For example, computing devices 104 can communicate with system 110 and/or edge devices 150 over an Internet (Web) protocol, via a gateway, via a command line interface, via a software developer kit (SDK), a standalone application, etc. As another example, computing devices 104 can use one or more executable applications or programs to interface with system 110.

Data sources 102 can correspond to distinct computing devices or systems that include or have access to data that can be ingested, indexed, and/or searched by system 110. Data sources 102 can include, but are not limited to, servers, routers, personal computers, mobile devices, internet of things (IoT) devices, factory machinery, industrial equipment, personal or commercial appliances, or hosting devices, such as computing devices in a shared computing resource environment on which multiple isolated execution environment (e.g., virtual machines, containers, etc.) can be instantiated, or other computing devices in an IT environment (e.g., device that includes computer hardware, e.g., processors, non-transitory computer-readable media, etc.). In some examples, edge devices 150 may receive the data from sensors 152 that is to be processed by system 110. As such, each one of edge devices 150 and its associated sensors 152 may constitute one of data sources 102.

The types of data that are generated by each of data sources 102 (and consequently by each of edge devices 150) can include machine data such as, for example and without limitation, server log files, activity log files, configuration files, messages, network packet data, performance measurements, sensor measurements, etc. In some cases, one or more applications executing on edge devices 150 may generate various types of machine data during operation. For example, a web server application executing on one of edge devices 150 may generate one or more web server logs detailing interactions between the web server and any number of computing devices 104 or other devices.

As another example, one of edge devices 150 may be implemented as a router and may generate one or more router logs that record information related to network traffic managed by the router. As yet another example, a database server application executing on one of edge devices 150 may generate one or more logs that record information related to requests sent from other devices (e.g., web servers, application servers, client devices, etc.) for data managed by the database server. Similarly, one of edge devices 150 may generate and/or store computing resource utilization metrics, such as, but not limited to, CPU utilization, memory utilization, number of processes being executed, etc. Any one or any combination of the files or data generated in such cases can be used as a data source for system 110.

As used herein, obtaining data from one of data sources 102 may refer to communicating with one of edge devices 150 to obtain data from edge device 150 (e.g., from sensors 152 associated with edge device 150 or some other data streams or directories on edge device 150, etc.). For example, obtaining data from one of data sources 102 may refer to requesting data from one of edge devices 150 and/or receiving data from edge device 150. In some such cases, edge device 150 can retrieve and return the requested data and/or system 110 can retrieve the data from edge device 150 (e.g., from a particular file stored on edge device 150).

Data intake and query system 110 can ingest, index, and/or store data from heterogeneous data sources and/or edge devices 150. For example, system 110 can ingest, index, and/or store any type of machine data, regardless of the form of the machine data or whether the machine data matches or is similar to other machine data ingested, indexed, and/or stored by system 110. In some cases, system 110 can generate events from the received data, group the events, and store the events in buckets. System 110 can also search heterogeneous data that it has stored, or search data stored by other systems (e.g., other system 110 systems or other non-system 110 systems). For example, in response to received queries, system 110 can assign one or more components to search events stored in the storage system or search data stored elsewhere.

As described herein in greater detail below, system 110 can use one or more components to ingest, index, store, and/or search data. In some embodiments, system 110 is implemented as a distributed system that uses multiple components to perform its various functions. For example, system 110 can include any one or any combination of an intake system to ingest data, an indexing system to index the data, a storage system to store the data, and/or a query system (or search system) to search the data, etc. In some cases, the components of system 110 are implemented as distinct computing devices having their own computer hardware (e.g., processors, non-transitory computer-readable media, etc.) and/or as distinct hosted devices (e.g., isolated execution environments) that share computing resources or hardware in a shared computing resource environment. In some examples, system 110 may include a machine learning deployment system 122 that trains machine learning models that are to be deployed at edge devices 150. The data used to train a machine learning model may be retrieved from the storage system based on a query received from one of computing devices 104.

The intake system can receive data from edge devices 150, perform one or more preliminary processing operations on the data, and communicate the data to the indexing system, query system, storage system, or to other systems (which may include, for example, data processing systems, telemetry systems, real-time analytics systems, data stores, databases, etc., any of which may be operated by an operator of system 110 or a third party). Given the amount of data that can be ingested by the intake system, in some embodiments, the intake system can include multiple distributed computing devices or components working concurrently to ingest the data. The preliminary processing operations performed by the intake system can include, but is not limited to, associating metadata with the data received from edge devices 150, extracting a timestamp from the data, identifying individual events within the data, extracting a subset of machine data for transmittal to the indexing system, enriching the data, etc.

In some environments, a user of a system 110 may install and configure, on computing devices owned and operated by the user, one or more software applications that implement some or all of the components of system 110. For example, with reference to FIG. 1, a user may install a software application on server computers owned by the user and configure each server to operate as one or more components of the intake system, indexing system, query system, shared storage system, or other components of system 110. This arrangement generally may be referred to as an “on-premises” solution. That is, system 110 is installed and operates on computing devices directly controlled by the user of system 110. Some users may prefer an on-premises solution because it may provide a greater level of control over the configuration of certain aspects of the system (e.g., security, privacy, standards, controls, etc.). However, other users may instead prefer an arrangement in which the user is not directly responsible for providing and managing the computing devices upon which various components of system 110 operate.

In certain examples, one or more of the components of system 110 can be implemented in a shared computing resource environment. In this context, a shared computing resource environment or cloud-based service can refer to a service hosted by one more computing resources that are accessible to end users over a network, for example, by using a web browser or other application on a client device to interface with the remote computing resources. For example, a service provider may provide system 110 by managing computing resources configured to implement various aspects of the system and by providing access to the system to end users via a network. Typically, a user may pay a subscription or other fee to use such a service. Each subscribing user of the cloud-based service may be provided with an account that enables the user to configure a customized cloud-based system based on the user's preferences.

Implementing system 110 in a shared computing resource environment can provide a number of benefits. In some cases, implementing system 110 in a shared computing resource environment can make it easier to install, maintain, and update the components of system 110. For example, rather than accessing designated hardware at a particular location to install or provide a component of system 110, a component can be remotely instantiated or updated as desired. Similarly, implementing system 110 in a shared computing resource environment or as a cloud-based service can make it easier to meet dynamic demand. For example, if system 110 experiences significant load at indexing or search, additional compute resources can be deployed to process the additional data or queries. In an “on-premises” environment, this type of flexibility and scalability may not be possible or feasible.

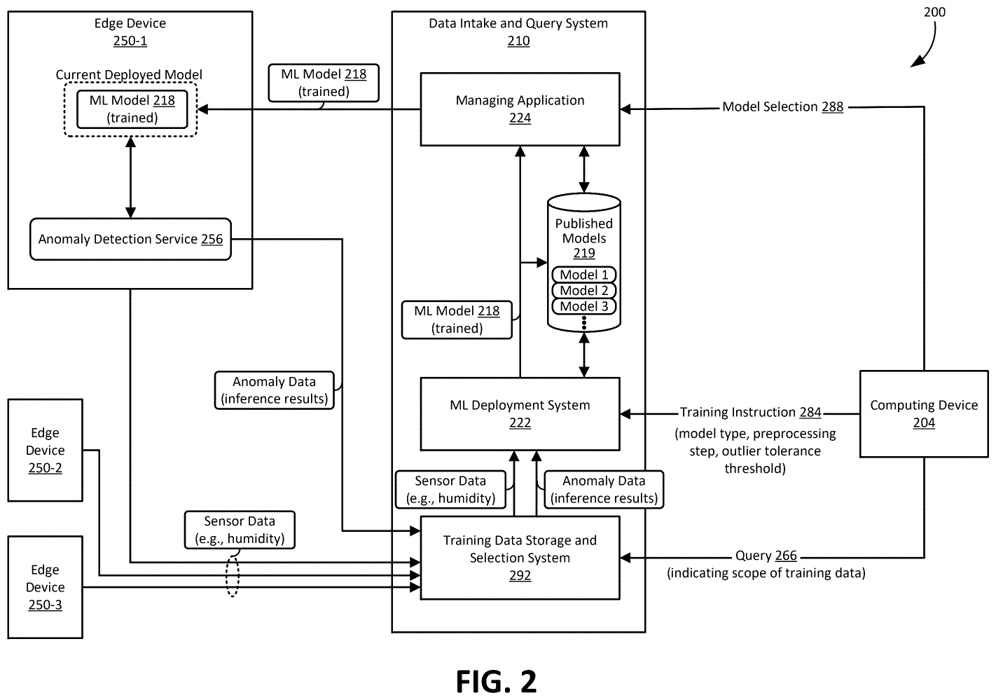

FIG. 2 illustrates a block diagram of an example data processing environment 200, according to some embodiments. As described herein, data processing environment 200 may include edge devices 250 (or “edge hubs”) that are devices that installed in customer networks and are able to get environmental data using built-in sensors but also able to retrieve data from devices in the network using a number of protocols (e.g., SNMP, Modbus, OPC UA, MQTT, etc.). Data processing environment 200 may further include a data intake and query system 210 and one or more computing devices 204, which may be user devices operated by users.

The present disclosure provides novel approaches for deploying and managing machine learning models at edge device 250 using a machine learning deployment system 222. One aspect of the invention enables users to create and refine machine learning models using machine learning deployment system 222. In some examples, a machine learning model 218 may be trained within machine learning deployment system 222, then published to a managing application 224 by storing machine learning model 218 within a set of published models 219 accessible to both managing application 224 and machine learning deployment system 222. Optionally, machine learning model 218 may be further optimized and repackaged into a format suitable for edge hub deployment. Subsequently, computing device 204 may provide a model selection 288 to select machine learning model 218 for deployment from managing application 224 to edge device 250, where it performs inference on incoming data. The inference results may then transmitted back to data intake and query system 210 for further analysis or action.

In some examples, machine learning model 218 may be trained to detect outliers using training data from multiple edge devices 250, including edge devices 250-1, 250-2, and 250-3. Machine learning model 218 may be any suitable model for detecting outliers, including a neural network, a recurrent neural network (RNN), an isolation forest, a one-class support vector machine (SVM), a density-based spatial clustering of applications with noise (DBSCAN) model, a model employing a density function algorithm, among other possibilities. In some examples, machine learning model 218 consists of an autoencoder neural network, particularly one incorporating long short-term memory (LSTM) layers. In one example, an untrained version of machine learning model 218 may be provided by computing device 204 to machine learning deployment system 222 for subsequent training. In another example, computing device 204 may provide a training instruction 284 to select an untrained version of machine learning model 218 for subsequent training at machine learning deployment system 222. In yet another example, computing device 204 may provide a training instruction 284 to select a trained version of machine learning model 218 for further training at machine learning deployment system 222. Training instruction 284 may specify a model type, a preprocessing step, or an outlier tolerance threshold used to train machine learning model 218. Adjusting the outlier tolerance threshold may increase or decrease the likelihood of detecting an anomaly.

The sensor data used for training may be selected and provided to machine learning deployment system 222 by a training data storage and selection system 292. In some examples, system 292 may receive sensor data from one or more of edge devices 250-1, 250-2, and 250-3. System 292 may then index and store the sensor data as described herein (e.g., system 292 may implement an indexing system, a search system, and/or a storage system as described herein). Computing device 204 may provide a query 266 to system 292 that indicates the scope of the training data that is to be used for training machine learning model 218. For example, query 266 may indicate a desired type of sensor data (e.g., humidity data), a desired capture time frame for the sensor data (e.g., a start day, a start time, an end day, and an end time), a desired sampling rate of the sensor data (e.g., 0.1 Hz, 1 Hz, 10 Hz, 100 Hz, etc.), among other possibilities. Based on query 266, system 292 may select a subset of the sensor data being stored and provide the selected subset of the sensor data to machine learning deployment system 222 to train machine learning model 218.

In some examples, query 266 may attempt to train machine learning model 218 exclusively on data that represents normal operating conditions. During training, machine learning model 218 learns the intricate patterns and correlations between the readings from all the different sensors over time. In some examples, when the trained model is later presented with new data, it can distinguish between normal and anomalous readings based on how well it can reconstruct the input. Data that cannot be reconstructed accurately is flagged as an outlier.

In one example, machine learning model 218 is an autoencoder neural network that consists of two main components: an encoder and a decoder. The input to machine learning model 218 may be a sequence of data points containing sensor readings at different times. In some examples, each point of the sequence of data points may be a vector containing the sensor readings from multiple sensors at a specific time (e.g., the humidity sensor of edge device 250-1, the humidity sensor of edge device 250-2, and the humidity sensor of edge device 250-3). The encoder's job may be to compress this input sequence into a lower-dimensional latent representation, often called a “bottleneck” or “context vector”. It may use LSTM layers to process the temporal sequences, allowing it to capture the time-dependent relationships within and between the sensor readings. The LSTM units process the data sequentially, remembering past information to inform the compression of the current input. The result is a dense vector that is a compressed summary of the normal patterns observed in the input sequence. The decoder may receive this compressed latent vector and attempt to reconstruct the original input sequence. Its architecture is typically a mirror of the encoder, using LSTM layers to expand the compressed representation back to the original data's dimensions. The output of the decoder may be a sequence of vectors that is its best attempt at recreating the initial sensor readings.

During training, the weights of machine learning model 218 may be adjusted to minimize the reconstruction error, which is the difference between the original input data and the output generated by the decoder. This process may rely on backpropagation and an optimization algorithm. During a forward pass, a batch of training sensor data is fed into machine learning model 218. The data passes through the encoder to be compressed and then through the decoder to be reconstructed. A loss function, typically mean squared error (MSE), may be used to calculate the difference between the original input vector and the reconstructed output vector. A higher value signifies a poorer reconstruction. During backpropagation, the calculated loss is used to compute the gradient for each weight in the model. This gradient indicates how much each weight contributed to the total error. The optimizer uses these gradients to update the weights throughout the encoder and decoder. The weights are nudged in the direction that will most effectively reduce the reconstruction error on the next pass. The size of these adjustments is controlled by a parameter called the learning rate.

This process is repeated for many iterations (epochs) with the entire dataset of normal operational data. Over time, machine learning model 218 becomes highly proficient at reconstructing the complex, normal patterns from a sensor, consistently producing a very low reconstruction error for such data. When this trained model later encounters an outlier in live data, a reading or pattern it has never seen before, it will be unable to reconstruct it accurately, resulting in a significantly higher reconstruction error. By setting a predetermined threshold for this error, the system can automatically flag these high-error instances as outliers.

After training, machine learning model 218 is uploaded to published models 219, where it may be selected by computing device 204 (via model selection 288) and deployed to edge device 250-1 by downloading the model onto edge device 250-1. Once deployed, anomaly detection service 256 may utilize machine learning model 218 by providing input sensor data to machine learning model 218, which may output anomaly data indicating whether an outlier is detected. As such, machine learning model 218 may be trained using sensor data captured by multiple edge devices 250 and deployed to a single one of edge devices 250. Embodiments of the present disclosure also facilitate the sharing of models among users or deploying a single model across multiple edge devices 250. For example, in addition to edge device 250-1, machine learning model 218 may be deployed to edge devices 250-2 and 250-3.

In some cases, each time machine learning model 218 performs an inference, the anomaly data may be relayed to training data storage and selection system 292. Such anomaly data may be selected based on query 266 for further training of machine learning model 218. For example, query 266 may specify whether anomaly data should be sent to machine learning deployment system 222 to train machine learning model 218, and may further specify what types of outcomes (e.g., false positives, true positives, true negatives, or false negatives) should be included. For example, if query 266 indicates that anomaly data with false positive outcomes should be selected to train machine learning model 218, the anomaly data and its accompanying sensor data (the sensor data from which the anomaly data was generated at edge devices 250) for which machine learning model 218 predicted an anomaly but no anomaly was present in the sensor data may be sent to machine learning deployment system 222. For example, if query 266 indicates that anomaly data with false negative outcomes should be selected to train machine learning model 218, the anomaly data and its accompanying sensor data (the sensor data from which the anomaly data was generated at edge devices 250) for which machine learning model 218 predicted no anomaly but an anomaly was present in the sensor data may be sent to machine learning deployment system 222.

The disclosed methods further address scenarios where edge device 250 is used to execute models requiring input data types not natively supported by data intake and query system 210, such as image or audio data, thereby enabling the ingestion of non-traditional, multi-modal data into system 210 after processing. In such a scenario, customers may generate a model using external toolsets, upload the model to managing application 224, and deploy it to edge device 250, which then runs the inference, and the resulting data is forwarded to system 210 for indexing and analysis. This approach supports the use of open-source models, accommodates customer-developed models, leverages the computational advantages of the NPU of edge device 250, and expands the indexing capabilities of system 210. It is noted, however, that the performance of such models may vary based on their complexity and size. In some examples, edge device 250 is used to generate actionable insights in environments with limited or intermittent connectivity to system 210, such as remote or cellular-connected locations. Edge device 250 may also function as a dedicated device for continuous model execution and responsive action based on inference results, reducing reliance on the system's scheduled job architecture.

As described above, machine learning model 218 may be trained within machine learning deployment system 222. Edge devices 250, which are registered within this environment, collect data from both internal and external sensors over a defined period. In some examples, external humidity data may be collected to facilitate comparison with standard use cases within machine learning deployment system 222. The collected data is used to create a smart outlier detection model employing a density function algorithm, with specific metrics and timeframes defined within searches. Machine learning model 218 may be refined through iterative threshold adjustments to optimize outlier detection accuracy. Upon reviewing the resulting experiment and analysis, the trained model is uploaded to published models 219 and is published to target applications within system 210, such as a search and reporting application for validation and managing application 224 for deployment. Published models may be accessible to computing devices 204 through a lookup table infrastructure, with metadata retrievable via REST API endpoints. The model files, typically stored in user-specific directories, are managed independently of the application folder structure, and access control is governed by user and application namespaces.

In some examples, once machine learning models are published, validation may be performed using the search and reporting application to ensure that single-value inputs can be accurately assessed for outlier status by the deployed model. Managing application 224 can enumerate all published models using the provided API, enabling the selection and deployment of appropriate models. As machine learning models are managed as specialized lookup tables, appropriate filtering may be applied to distinguish them from other lookup files. In some cases, deployment of machine learning model 218 from managing application 224 to edge device 250 may entail additional optimization or repackaging steps, such as serializing the model into a pickle file format for compatibility, although such optimizations may not be needed. Model transfer to edge device 250 can be accomplished through several mechanisms: saving the model to an asset storage, exposing the model via a REST endpoint in managing application 224 (suitable for air-gapped deployments), or chunking the model file for transfer over messages. Each approach offers distinct advantages and trade-offs in terms of security, networking configuration, and operational efficiency.

Once deployed, anomaly detection service of edge device 250 may manage model inference. Configuration settings define which algorithms are enabled, and anomaly detection service 256 may instantiate algorithm-specific objects through a common abstraction layer. Upon receiving sensor data via MQTT subscriptions, the service invokes the relevant algorithm's inference method, determining whether input values are anomalous, updating the model as necessary, and persisting changes for future use. While certain implementations may use pickle serialization, the present disclosure contemplates enhanced security through algorithm-specific serialization codecs, as recommended by production security guidelines. After inference, results may be transmitted back to system 210 for indexing, alerting, or further analysis.

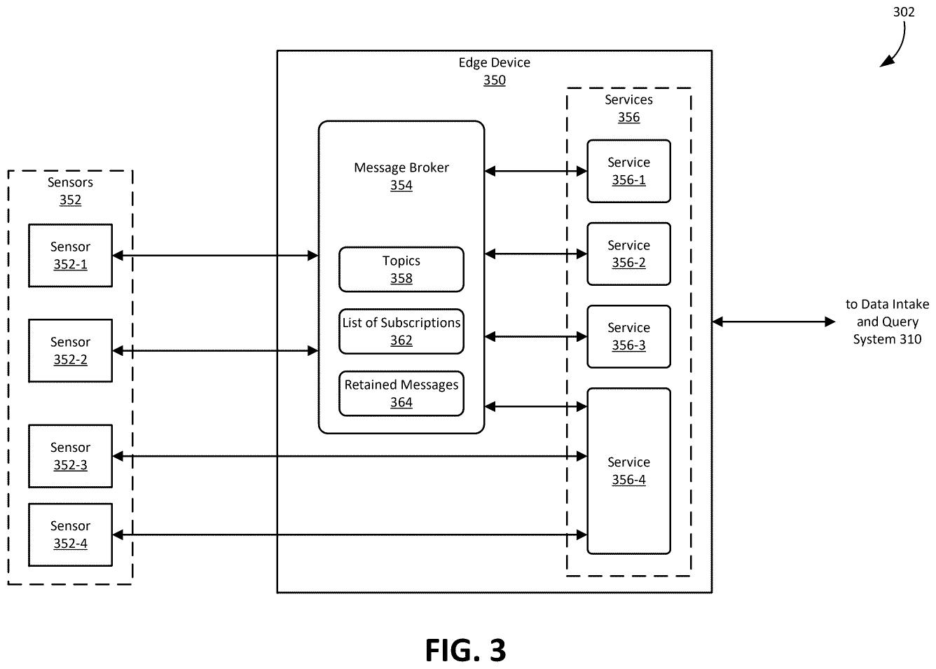

FIG. 3 illustrates a block diagram of an example data source 302, according to some embodiments. In the illustrated example, data source 302 includes an edge device 350 that is communicatively coupled to a set of sensors 352. Edge device 350 may include various hardware elements and software application programs that may be used by the hardware elements. For example, edge device 350 may include a message broker 354 and a set of services 356 that are configured to run on edge device 350. For example, instructions for executing message broker 354 and services 356 may be stored on the system memory of edge device 350 and, upon startup of edge device 350, these instructions may be sequentially loaded into one or more processors of edge device 350 so that these programs are caused to run on edge device 350 to carry out the functionalities described below. In some examples, edge device 350 is physically installed at an edge of a network of computational devices. For example, edge device 350 is a physical “box” with a housing configured to be installed in a data center, on an equipment rack, on an equipment shelf, or the like. These instructions may further include operations that register the edge device 350 with a data intake and query system 310. Registration of edge device 350 is described in greater detail below.

Message broker 354 is executed by edge device 350 to provide communication between the various software and hardware entities within the data processing environment. For example, message broker 354 may receive and send messages between several clients in accordance with a publish-subscribe network protocol. In some examples, message broker 354 may implement a topic-based publish-subscribe protocol in which messages are published by clients on certain topics and the published messages are delivered by message broker 354 to the clients that are subscribed to those topics. In one example, message broker 354 is implemented according to the MQTT protocol. In other examples, message broker 354 is implemented according to any suitable publish-subscribe-type of messaging protocol. Clients may subscribe to one or more topics and message broker 354 may track these subscriptions by maintaining a list of each subscription.

Message broker 354 may directly or indirectly communicate with a number of clients, which may include one or more of sensors 352 and one or more of services 356. Each of the clients may subscribe to one of a number of topics 358 that are maintained by message broker 354. Topics 358 may be a file or data structure that is prepopulated with the possible topics to which a client may subscribe or, in some examples, topics 358 may be updated over time. For example, additional topics may be added to topics 358 once the topic is first subscribed or published to, and topics may be removed from topics 358 once the last client unsubscribes from the topic.

Message broker 354 may maintain a list of subscriptions 362 to track the client subscriptions. In general, list of subscriptions 362 may include one or more subscriptions that indicate which of the set of clients are subscribed to which of topics 358. List of subscriptions 362 may be a file or data structure that is prepopulated with the subscriptions or, in some examples, is updated over time by, for example, adding a subscription each time a client subscribes to a topic to which the client was not previously subscribed, and removing a subscription each time a client unsubscribes from a topic. As described above, a client may subscribe to a topic that is previously listed in topics 358 or is a new topic that may then be added to topics 358.

In some examples, message broker 354 may maintain a set of retained messages 364 that includes recent published messages received by message broker 354. In some examples, retained messages 364 may be used to allow newly-subscribed clients to a topic to receive messages that were published prior to the clients being subscribed. In some examples, the publish-subscribe protocol may not require that at least one client must first be subscribed to a particular topic before any message can be published to that topic, and therefore a client that publishes a message has no guarantee that a subscribing client actually receives the message. By maintaining retained messages 364, clients may receive messages that they would otherwise have missed and, furthermore, a published message may be more likely to be received by a desired recipient. In various examples, retained messages 364 may store the N most recent published messages, all messages published within the last T amount of time, or the N most recent published messages received within the last T amount of time, among other possibilities.

As noted above, clients of message broker 354 may include any of sensors 352 and any of services 356. In various examples, one or more of sensors 352 may be clients of message broker 354 via direct communication with message broker 354 or via one of services 356 that may act as an intermediary between message broker 354 and sensors 352. For example, in the illustrated embodiment, sensors 352-1 and 352-2 may be clients of and may communicate directly with message broker 354, while sensors 352-3 and 352-4 may be clients of message broker 354 and may communicate via service 356-4, which may act as a sensor manager service that causes a connected sensor to perform various actions that change the operation of the connected sensor (e.g., turn on/off the sensor, increase/decrease the rate that sensor data is captured or transmitted).

Further in the illustrated example, services 356-1, 356-2, and 356-3 may be clients of the message broker 354 and may communicate directly with message broker (e.g., by virtue of being executed on the same hardware). Services 356 may publish messages on certain topics and subscribe to certain topics so as to receive messages published to those topics. One or more of services 356 may communicate with a data intake and query system 310 by, for example, receiving requests from system 310 to subscribe to certain topics that system 310 is interested in, and transmit messages published on those topics to system 310.

Sensors 352 may include one or more of a variety of sensor types such as, without limitation, a light sensor, an image capture sensor, a sound sensor, a vibration sensor, an accelerometer, a gyroscope, a pressure sensor, a humidity sensor, a gas sensor, a location sensor, among other possibilities. The illustrated sensors 352 can be physically disposed internal to, and/or external to edge device 350. For example, sensors 352 may include an internally disposed vibration sensor and/or an externally disposed vibration sensor that provide vibration measurements within edge device 350 and of the external environment, respectively. Externally disposed sensors may provide measurement data corresponding to a target device that is located within the data processing environment, such as a server computer, to which one or more of sensors 352 are attached.

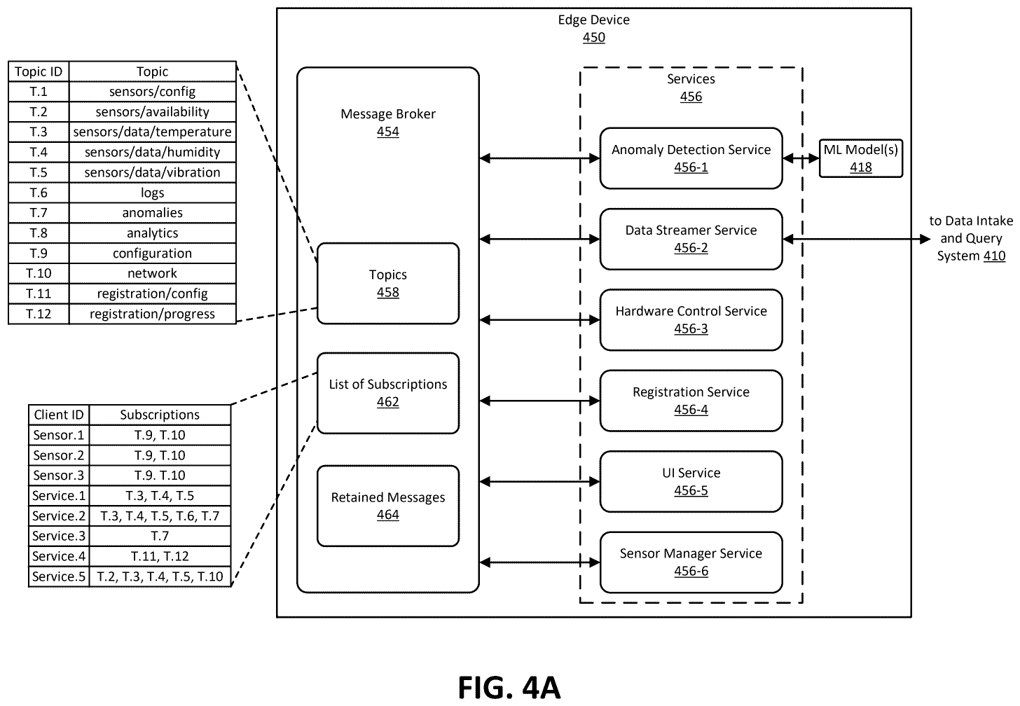

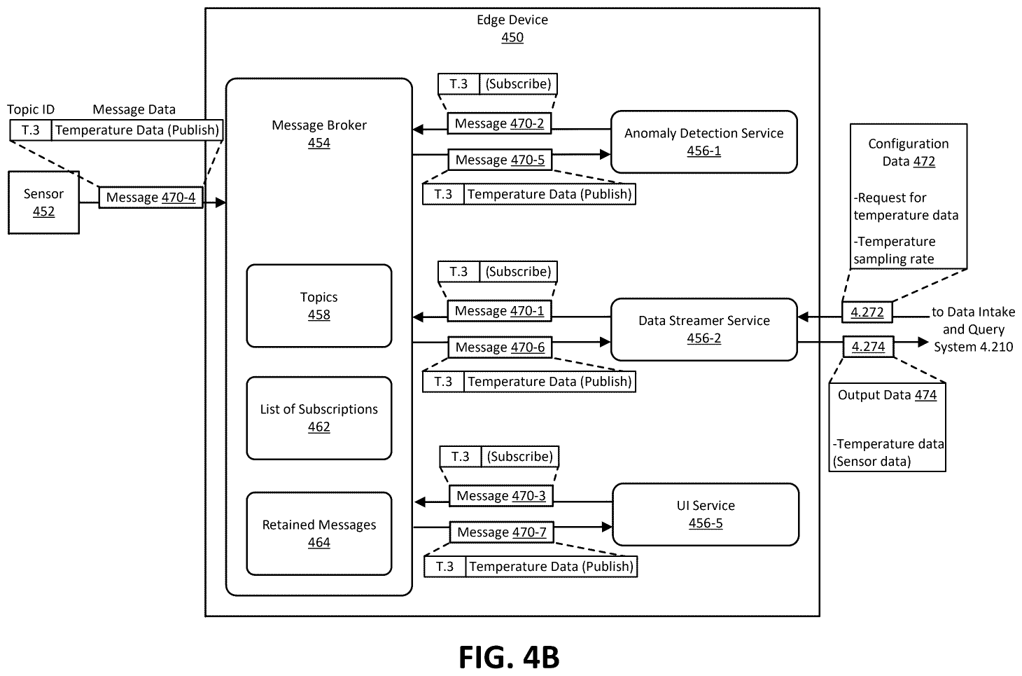

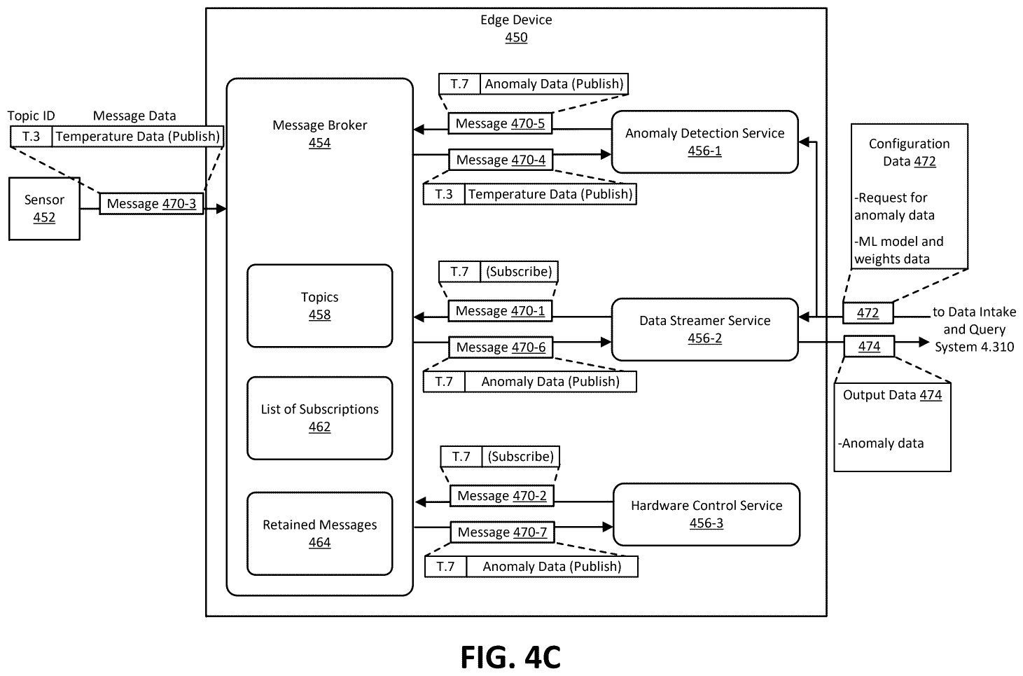

FIGS. 4A-4C illustrate block diagrams of an example edge device 450. In FIG. 4A, the edge device 450 includes a message broker 454 and a set of services 456 that are configured to run on the edge device 450. The message broker 454 may maintain a set of topics 458, a list of subscriptions 462, and a set of retained messages 464. In the illustrated example, a set of topic IDs and client IDs are used by the message broker 454 to distinguish between different topics and clients, respectively.

The illustrated example may represent the contents of the topics 458 and the list of subscriptions 462 at a particular point in time while the message broker 454 is running on the edge device 450. The topics 458 include Topics T.1-T.12, which include topics for different types of sensor measurements, including Topic T.3 for temperature measurements, Topic T.4 for humidity measurements, and Topic T.5 for vibration measurements, as well as topics related to logs (Topic T.6) and anomalies (Topic T.7), among others. As described above, the number of topics in the topics 458 may increase or decrease when new topics are subscribed to or published on or when topics are no longer being subscribed to or published on.

The list of subscriptions 462 includes subscriptions for clients corresponding to sensors as well as clients corresponding to the services 456. In the illustrated example, the list of subscriptions 462 includes that Client Sensor.1 is subscribed to Topics T.9 and T.10, that Client Service.1 is subscribed to Topics T.3, T.4, and T.5, among others. As shown, multiple clients may be subscribed to a single topic, such as each of Clients Sensor.1, Sensor.2, and Sensor.3 being subscribed to Topics T.9 and T.10. Furthermore, sensor clients as well as service clients may be subscribed to a same topic, such as Clients Sensor.1 and Service.5 being subscribed to Topic T.10.

The illustrated example also shows several examples for services 456, including an anomaly detection service 456-1, a data streamer service 456-2, a hardware control service 456-3, a registration service 456-4, a user interface (UI) service 456-5, and a sensor management service 456-6. In some examples, the anomaly detection service 456-1 may collect certain sensor data acquired by the sensors and detect anomalies associated with the sensor data. The anomaly detection service 456-1 may employ one or more machine learning models 418, where various sensor data is inputted into machine learning model(s) 418 to generate an output indicative of whether an anomaly/outlier was detected. For example, temperature data may be received by the anomaly detection service 456-1 and be inputted into a specific temperature machine learning model in order to identify anomalies and/or other alert conditions associated with a target operating temperature of a target device, the surrounding environment, or of the edge device 450 itself.

In some examples, the data streamer service 456-2 may transmit data collected at the edge device 450 to a data intake and query system 410. The data streamer service 456-2 may subscribe to one or more of the topics 458 in accordance with a configuration file or configuration data, which may be obtained (e.g., received) by the data streamer service 456-2 from an external device, such as the system 410. For example, a configuration file received by the data streamer service 456-2 may indicate that certain sensor data (e.g., temperature data) is to be sent to the system 410. The data streamer service 456-2 may then subscribe to the corresponding topic (e.g., Topic T.3) and relay data contained in any published messages back to the system 410.

The hardware control service 456-3 may control and manage the hardware components of the edge device 450. The registration service 456-4 may register the edge device 450 with a remote application running on a remote device, allowing the remote device to send configuration data to the edge device 450 for modifying the functionality of one or more of the services 456. The UI service 456-5 may manage the UI of the edge device 450 as well as any other I/O devices connected to or integrated with the edge device 450. The sensor management service 456-6 may communicate with one or more connected sensors and perform various actions that change the operation of the sensors (e.g., increase the rate that certain sensor data is measured and/or transmitted).

FIG. 4B illustrates an example operation of edge device 450 upon receiving configuration data 472 from a sender that is external to edge device 450. In the illustrated example, edge device 450 includes message broker 454 and services 456 including anomaly detection service 456-1, data streamer service 456-2, and UI service 456-5 that are configured to run on edge device 450. In the illustrated example, configuration data 472 is received by edge device 450 (e.g., by data streamer service 456-2) from an external sender. In various examples, data streamer service 456-2 may obtain configuration data 472 using a variety of techniques. In one example, data streamer service 456-2 may obtain configuration data 472 directly from the external sender. In another example, a separate service running on edge device 550 (referred to as the “pulse service”) may receive configuration data 472 from the external sender and may publish a message containing configuration data 472 on a particular topic for configuration data (such as Topic T.9) by sending the message to the message broker. Data streamer service 456-2, which may have previously subscribed to the particular topic, may receive the published message from the message broker containing the configuration data. As such, in some examples, data streamer service 456-2 may obtain configuration data 472 via message broker 354 by subscribing to a particular topic for configuration data.

In various examples, the external sender may be data intake and query system 410, a computing or client device, a mobile device that is wirelessly connected to edge device 450, among other possibilities. In general, configuration data 472 may include data for modifying the operation of clients of message broker 454, including services 456 and sensor 452. Configuration data 472 may be received in the form of a configuration file.

In the illustrated example, configuration data 472 includes a request for temperature data (which is an example of a type of sensor data) and further specifies a particular temperature sampling rate (which is an example of a sensor sampling rate). Data streamer service 456-2 may parse configuration data 472 to identify the request for temperature data as well as the specified temperature sampling rate. In response to data streamer service 456-2 obtaining configuration data 472, data streamer service 456-2 may send a message 470-1 to message broker 454 to subscribe to Topic T.3 (i.e., the topic for temperature measurements). Data streamer service 456-2 may also cause sensor 452 (e.g., through the sensor manager service) to modify its temperature sampling rate to the specified temperature sampling rate.

In response to receiving message 470-1, message broker 454 may update list of subscriptions 462 to indicate that data streamer service 456-2 is subscribed to Topic T.3. In some examples, message broker 454 may update topics 458 to include Topic T.3 or, alternatively, prior to updating list of subscriptions 462, message broker 454 may verify that Topic T.3 is included in topics 458. Optionally, further in response to data streamer service 456-2 obtaining the configuration data 472, anomaly detection service 456-1 and UI service 456-5 may be caused to send messages 470-2 and 470-3, respectively, to message broker 454 to subscribe to Topic T.3. In response to receiving messages 470-2 and 470-3, message broker 454 may update list of subscriptions 462 to indicate that anomaly detection service 456-1 and UI service 456-5 are subscribed to Topic T.3.

Thereafter, sensor 452 may perform one or more temperature measurements at the specified temperature sampling rate. These measurements may be included in a message 470-4 (in the form of temperature data), which may be sent by sensor 452 to message broker 454 to publish message 470-4 on Topic T.3. In response to receiving message 470-4, message broker 454 may examine list of subscriptions 462 to identify which clients are subscribed to Topic T.3. After identifying that each of the services 456-1, 456-2, and 456-5 is subscribed to Topic T.3, the message broker 454 may send messages 470-5, 470-6, and 470-7 to services 456-1, 456-2, and 456-5, respectively, with each of these sent published messages including the same temperature data from message 470-4.

In response to receiving message 470-6, data streamer service 456-2 may prepare output data 474 that includes the temperature data and send output data 474 to system 410 for processing as described herein. In response to receiving message 470-5, anomaly detection service 456-1 may analyze the temperature data to possibly detect any anomalies in the data. In response to receiving message 470-7, UI service 456-5 may adjust the display of the edge device 450 to display the temperature measurements captured by sensor 452.

FIG. 4C illustrates an additional example operation of edge device 450 upon receiving configuration data 472 from a sender that is external to edge device 450. In the illustrated example, edge device 450 includes message broker 454 and services 456 including anomaly detection service 456-1, data streamer service 456-2, and hardware control service 456-5 that are configured to run on edge device 450. In the illustrated example, configuration data 472 is received by edge device 450 (e.g., obtained and/or received by anomaly detection service 456-1 and data streamer service 456-2) from an external sender. In various examples, the external sender may be data intake and query system 410, a computing or client device, a mobile device that is wirelessly connected to edge device 450, among other possibilities. In general, configuration data 472 may include data for modifying the operation of clients of message broker 454, including services 456 and sensor 452.

In the illustrated example, configuration data 472 includes a request for anomaly data and further provides a machine learning model and associated weights to be used by anomaly detection service 456-1. Configuration data 472 is obtained by data streamer service 456-2 and optionally by anomaly detection service 456-1. Data streamer service 456-2 may parse configuration data 472 to identify the request for anomaly data as well as the machine learning model and associated weights. In response to data streamer service 456-2 obtaining configuration data 472, data streamer service 456-2 may send a message 470-1 to message broker 454 to subscribe to Topic T.7 (i.e., the topic for anomaly data). Data streamer service 456-2 may also cause anomaly detection service 456-1 to load the machine learning model and associated weights to be used for processing received sensor data.

In response to receiving message 470-1, message broker 454 may update list of subscriptions 462 to indicate data streamer service 456-2 is subscribed to Topic T.7. In some examples, message broker 454 may update topics 458 to include Topic T.7 or, alternatively, prior to updating list of subscriptions 462, message broker 454 may verify that Topic T.7 is included in topics 458. Further in response to data streamer service 456-2 and/or anomaly detection service 456-1 obtaining configuration data 472, anomaly detection service 456-1 may send a message (not shown) to message broker 454 to subscribe to one or more topics that are related to the input data for the machine learning model (e.g., topics related to temperature data or other sensor data). For example, anomaly detection service 456-1 may subscribe to Topic T.3. Optionally, in response to data streamer service 456-2 obtaining configuration data 472, hardware control service 456-3 may be caused to send a message 470-2 to message broker 454 to subscribe to Topic T.7. In response to receiving messages 470-2, message broker 454 may update list of subscriptions 462 to indicate that hardware control service 456-3 is subscribed to Topic T.7.

Thereafter, sensor 452 may perform one or more temperature measurements. These measurements may be included in a message 470-3 (in the form of temperature data), which may be sent by sensor 452 to message broker 454 to publish message 470-3 on Topic T.3. In response to receiving message 470-3, message broker 454 may examine list of subscriptions 462 to identify which clients are subscribed to Topic T.3. After identifying that anomaly detection service 456-1 is subscribed to Topic T.3, message broker 454 may send messages 470-4 to the anomaly detection service 456-1, with the sent published message including the same temperature data from message 470-3.

In response to receiving message 470-4, anomaly detection service 456-1 may provide the temperature data as input to the machine learning model, which may produce an output that indicates whether or not an anomaly was detected. In the case where the output of the machine learning model indicates that an anomaly was detected based on the temperature data, anomaly detection service 456-1 may generate a message 470-5 that includes anomaly data that identifies the detected anomaly. Message 470-5 is sent by anomaly detection service 456-1 to message broker 454 to publish message 470-5 on Topic T.7.

In response to receiving message 470-5, message broker 454 may examine list of subscriptions 462 to identify which clients are subscribed to Topic T.7. After identifying that each of services 456-2 and 456-3 is subscribed to Topic T.7, message broker 454 may send messages 470-6 and 470-7 to services 456-2 and 456-3, respectively, with each of these sent published messages including the same anomaly data from message 470-5. In response to receiving message 470-6, data streamer service 456-2 may prepare output data 474 that includes the anomaly data and send output data 474 to system 410 for processing (e.g., including machine learning model training) as described herein. In response to receiving message 470-7, hardware control service 456-3 may control one or more hardware elements of edge device 450 based on the detected anomaly. For example, hardware control service 456-3 may need to power off or reset the device, or cause warning indicators (e.g., LED lights) to be triggered to alert a user of edge device 450 as to the detected anomaly.

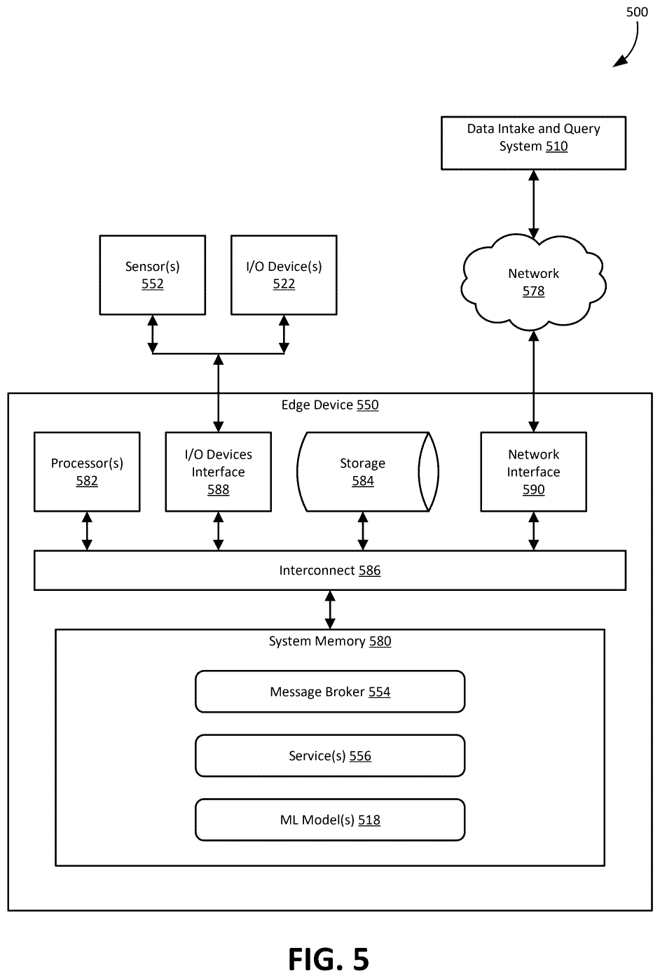

FIG. 5 illustrates a block diagram of an example edge device 550 within a data processing environment 500, according to some embodiments. As shown, data processing environment 500 may include, without limitation, a data intake and query system 510 and an edge device 550 communicating with one another over one or more communications networks 578. Edge device 550 may include, without limitation, one or more processor(s) 582, storage 584, an input/output (I/O) device interface 588, a network interface 590, an interconnect 586, and system memory 580. System memory 580 may include a message broker 554, one or more services 556, and one or more machine learning models 518.

In general, processor(s) 582 may retrieve and execute programming instructions stored in the system memory 580, such as the message broker 554, the services 556, and machine learning models 518, and any operating system stored therein. Processor(s) 582 may include any technically-feasible form of a processing device configured to process data and execute program code. The Processor(s) 582 may include, for example, a central processing unit (CPU), a neural processing unit (NPU), a graphics processing unit (GPU), an application-specific integrated circuit (ASIC), a field-programmable gate array (FPGA), and so forth. Processor(s) 582 may store and retrieve application data residing in system memory 580. In operation, processor(s) 582 may be the manager processor of edge device 550, controlling and coordinating operations of the other system components.

Storage 584 may be a disk drive storage device. Although shown as a single unit, storage 584 may be a combination of fixed and/or removable storage devices, such as fixed disc drives, floppy disc drives, tape drives, removable memory cards, or optical storage, network attached storage (NAS), or a storage area-network (SAN). Processor(s) 582 may communicate with other computing devices and systems via network interface 590, where network interface 590 is configured to transmit and receive data via communications network 578.

Interconnect 586 facilitates transmission, such as of programming instructions and application data, between processor(s) 582, input/output (I/O) device interface 588, storage 584, network interface 590, and system memory 580. I/O device interface 588 is configured to transmit and receive data to and from one or more sensors 552 and I/O devices 522. I/O devices 522 may include one or more input devices (e.g., a keyboard, buttons, stylus, microphone, etc.) and/or one or more output devices (e.g., speaker, light-emitting diodes, etc.). In some instances, I/O devices 522 includes a display device that displays an image and, in some examples, is integrated with edge device 550. In various examples, the display device may be a liquid crystal display (LCD) display, organic light-emitting diode (OLED) display, or a digital light processing (DLP) display. In some instances, sensors 552 may include a camera that acquires images via a lens and converts the images into digital form, which may then be displayed on the display device.

Sensors 552 may include one or more of a variety of sensor types such as, without limitation, a light sensor, an image capture device (e.g., a camera), a sound sensor (e.g., microphone), a vibration sensor, one or more accelerometers (for measuring accelerations in one or more directions), one or more gyroscopes (for measuring rotations in one or more directions), a pressure sensor, a humidity sensor, a gas sensor (e.g., a CO₂ sensor), a location sensor (e.g., a Global Navigation Satellite System (GNSS) receiver), among other possibilities. While sensors 552 are shown as being external to edge device 550, sensors 552 may be internal or external to edge device 550. For example, sensors 552 may include an internal vibration sensor and/or an external vibration sensor that provide vibration measurements within edge device 550 and of the external environment, respectively. External sensors may provide measurement data corresponding to a target device, such as a server computer, to which one or more of sensors 552 are attached.

Services 556 may include a sensor manager service that may cause one or more of sensors 552 to perform various actions that change the operation of sensors 552 (e.g., increase rate that sensor data is transmitted) and/or the operation of sensors 552 (e.g., turn on a camera and/or a microphone, etc.). Edge device 550 may execute message broker 554 to communicate with other devices within data processing environment 500. For example, message broker 554 could receive sensor data from one or more of sensors 552 and may send the data to data intake and query system 510. In various examples, edge device 550 may process the received data. For example, edge device 550 may retrieve one or more of machine learning models 518 in order to process incoming data. In some embodiments, one or more machine learning models 518 are locally stored and updated at the edge device 550 without receiving updates from another device.

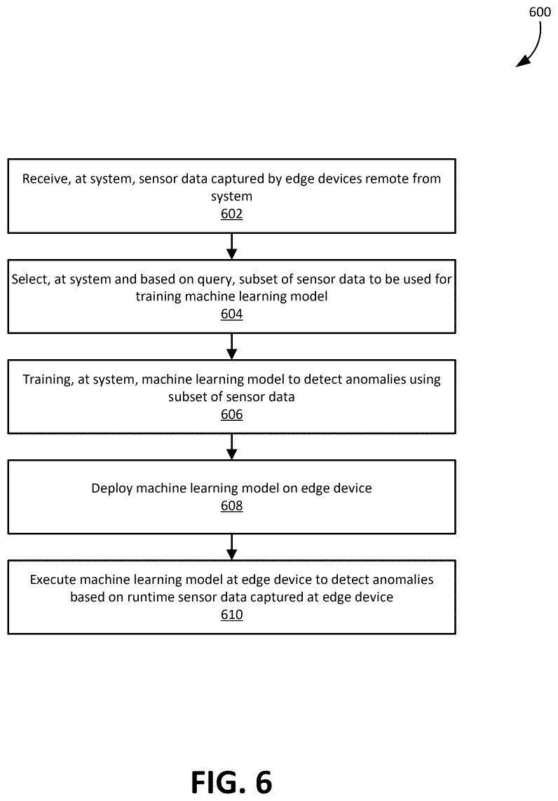

FIG. 6 illustrates a flowchart of an example process 600 for detecting anomalies at an edge device integrated with a data intake system, according to some embodiments. The example process 600 can be implemented, for example, by a system that comprises a processor and a non-transitory computer-readable medium. The non-transitory computer readable medium can be storing instructions that, when executed by the processor, can cause the processor to perform the operations of the illustrated process 600. Alternatively or additionally, the process 600 can be implemented using a non-transitory computer-readable medium storing instructions that, when executed by one or more processors, cause the one or more processors to perform the operations of the process 600 of FIG. 6.

At step 602, sensor data captured by a set of edge devices (e.g., edge devices 150, 250, 350, 450, 550) is received at a system (e.g., systems 110, 210, 310, 410, 510, 710). The set of edge devices may be remote from the system.

At step 604, a subset of the sensor data to be used for training a machine learning model is selected (e.g., machine learning models 218, 418, 518) at the system based on a query (e.g., queries 266, 966). The query may be sent by a computing device (e.g., computing devices 104, 204, 704, 804, 904) to the system. The query may specify at least one of: a type of the sensor data, a capture time frame for the sensor data, or a sampling rate of the sensor data.

At step 606, the machine learning model is trained at the system to detect anomalies using the subset of the sensor data.

At step 608, after training the machine learning model, the machine learning model is deployed on the edge device.

At step 610, the machine learning model is executed at the edge device to detect one or more anomalies based on runtime sensor data captured at the edge device. The runtime sensor data may be captured by a sensor (e.g., sensors 152, 352, 552) associated with the edge device. The sensor may be one of: an image capture sensor, a sound sensor, a vibration sensor, an accelerometer, a gyroscope, a pressure sensor, a humidity sensor, a gas sensor, or a location sensor.

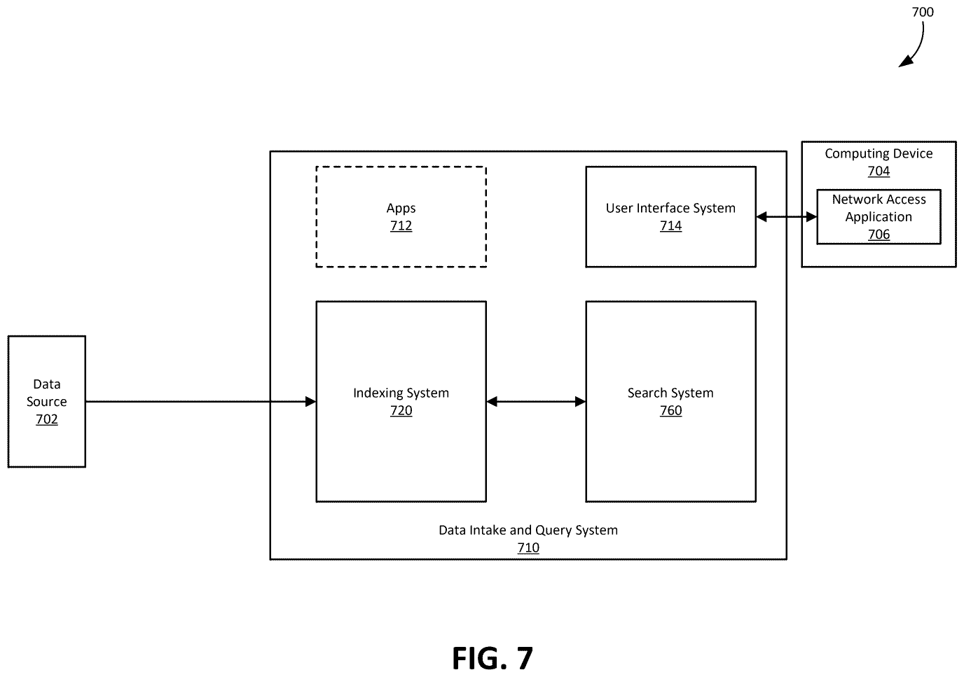

FIG. 7 is a block diagram illustrating an example computing environment 700 that includes a data intake and query system 710. Data intake and query system 710 obtains data from a data source 702 in computing environment 700, and ingests the data using an indexing system 720. A search system 760 of data intake and query system 710 enables users to navigate the indexed data. Though drawn with separate boxes, in some implementations indexing system 720 and search system 760 can have overlapping components. A computing device 704, running a network access application 706, can communicate with data intake and query system 710 through a user interface system 714 of the data intake and query system 710. Using computing device 704, a user can perform various operations with respect to the data intake and query system 710, such as administration of the data intake and query system 710, management and generation of “knowledge objects,” initiating of searches, and generation of reports, among other operations. Data intake and query system 710 can further optionally include apps 712 that extend the search, analytics, and/or visualization capabilities of the data intake and query system 710.

Data intake and query system 710 can be implemented using program code that can be executed using a computing device. A computing device is an electronic device that has a memory for storing program code instructions and a hardware processor for executing the instructions. The computing device can further include other physical components, such as a network interface or components for input and output. The program code for data intake and query system 710 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for data intake and query system 710 can execute on a single computing device, or may be distributed over multiple computing devices. For example, the program code can include instructions for executing both indexing and search components (which may be part of indexing system 720 and/or search system 760, respectively), and can be executed on a computing device that also provides data source 702. As another example, the program code can execute on one computing device, where the program code executes both indexing and search components, while another copy of the program code executes on a second computing device that provides data source 702. As another example, the program code can execute only an indexing component or only a search component. In this example, a first instance of the program code that is executing the indexing component and a second instance of the program code that is executing the search component can be executing on the same computing device or on different computing devices.

Data source 702 of computing environment 700 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide data source 702 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, indexing system 720 obtains machine date from data source 702 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. Indexing system 720 does not require prior knowledge of the structure of incoming data (e.g., indexing system 720 does not need to be provided with a schema describing the data). Additionally, indexing system 720 retains a copy of the data as it was received by indexing system 720 such that the original data is always available for searching (e.g., no data is discarded, though, in some examples, indexing system 720 can be configured to do so).

Search system 760 searches the data stored by indexing system 720. As discussed in greater detail below, search system 760 enables users associated with computing environment 700 (and possibly also other users) to navigate the data, generate reports, and visualize results in “dashboards” output using a graphical interface. Using the facilities of search system 760, users can obtain insights about the data, such as retrieving events from an index, calculating metrics, searching for specific conditions within a rolling time window, identifying patterns in the data, and predicting future trends, among other examples. To achieve greater efficiency, search system 760 can apply map-reduce methods to parallelize searching of large volumes of data. Additionally, because the original data is available, search system 760 can apply a schema to the data at search time. This allows different structures to be applied to the same data, or for the structure to be modified if or when the content of the data changes. Application of a schema at search time may be referred to herein as a late-binding schema technique.

User interface system 714 provides mechanisms through which users associated with computing environment 700 (and possibly others) can interact with the data intake and query system 710. These interactions can include configuration, administration, and management of indexing system 720, initiation and/or scheduling of queries to search system 760, receipt or reporting of search results, and/or visualization of search results. User interface system 714 can include, for example, facilities to provide a command line interface or a web-based interface.

Users can access user interface system 714 using a computing device 704 that communicates with data intake and query system 710, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with computing environment 700. For example, a person can log in as a particular user and, using the user's digital information, can access the data intake and query system 710. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users' digital information, including assignment of user identifiers, management of security credentials, control of which persons are associated with which users, and so on.

Computing device 704 can provide a human-machine interface through which a person can have a digital presence in computing environment 700 in the form of a user. Computing device 704 is an electronic device having one or more processors and a memory capable of storing instructions for execution by the one or more processors. Computing device 704 can further include input/output (I/O) hardware and a network interface. Applications executed by computing device 704 can include a network access application 706, which can a network interface of the client computing device 704 to communicate, over a network, with user interface system 714 of the data intake and query system 710. User interface system 714 can use network access application 706 to generate user interfaces that enable a user to interact with the data intake and query system 710. A web browser is one example of a network access application. A shell tool can also be used as a network access application. In some examples, data intake and query system 710 is an application executing on computing device 704. In such examples, network access application 706 can access user interface system 714 without needed to go over a network.

Data intake and query system 710 can optionally include apps 712. An app of data intake and query system 710 is a collection of configurations, knowledge objects (a user-defined entity that enriches the data in the data intake and query system 710), views, and dashboards that may provide additional functionality, different techniques for searching the data, and/or additional insights into the data. Data intake and query system 710 can execute multiple applications simultaneously. Example applications include an information technology service intelligence application, which can monitor and analyze the performance and behavior of computing environment 700, and an enterprise security application, which can include content and searches to assist security analysts in diagnosing and acting on anomalous or malicious behavior in computing environment 700.

Though FIG. 7 illustrates only one data source, in practical implementations, computing environment 700 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of computing environment 700, data intake and query system 710 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, computing environment 700 can include on-prem and cloud-based computing resources, or only cloud-based resources. For example, an entity may have on-prem computing devices and a private cloud. In this example, the entity operates data intake and query system 710 and can choose to execute data intake and query system 710 on an on-prem computing device or in the cloud. In another example, a provider entity operates data intake and query system 710 in a public cloud and provides the functionality of data intake and query system 710 as a service, for example under a Software-as-a-Service (SaaS) model. In this example, the provider entity can provision a separate tenant (or possibly multiple tenants) in the public cloud network for each subscriber entity, where each tenant executes a separate and distinct instance of the data intake and query system 710. In some implementations, the entity providing data intake and query system 710 is itself subscribing to the cloud services of a cloud service provider. As an example, a first entity provides computing resources under a public cloud service model, a second entity subscribes to the cloud services of the first provider entity and uses the cloud computing resources to operate the data intake and query system 710, and a third entity can subscribe to the services of the second provider entity in order to use the functionality of the data intake and query system 710. In this example, the data sources are associated with the third entity, users accessing data intake and query system 710 are associated with the third entity, and the analytics and insights provided by data intake and query system 710 are for purposes of the third entity's operations.

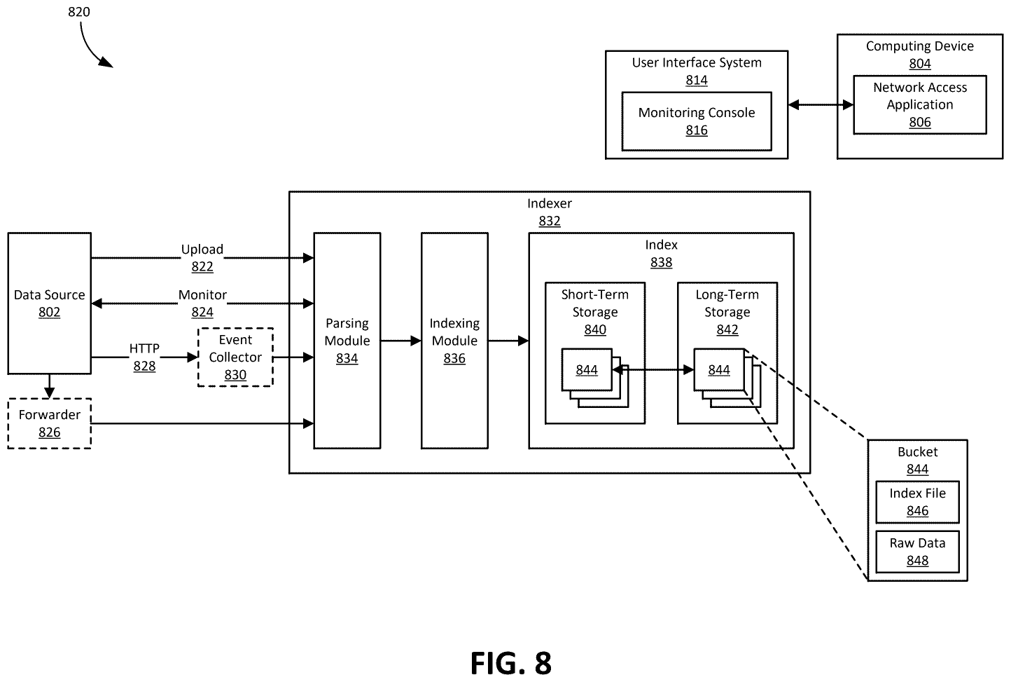

FIG. 8 is a block diagram illustrating in greater detail an example of an indexing system 820 of a data intake and query system, such as data intake and query system 710 of FIG. 7. Indexing system 820 of FIG. 8 uses various methods to obtain machine data from a data source 802 and stores the data in an index 838 of an indexer 832. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. Indexing system 820 enables the data intake and query system to obtain the machine data produced by data source 802 and to store the data for searching and retrieval.

Users can administer the operations of indexing system 820 using a computing device 804 that can access indexing system 820 through a user interface system 814 of the data intake and query system. For example, computing device 804 can be executing a network access application 806, such as a web browser or a terminal, through which a user can access a monitoring console 816 provided by user interface system 814. The monitoring console 816 can enable operations such as: identifying data source 802 for indexing; configuring indexer 832 to index the data from data source 802; configuring a data ingestion method; configuring, deploying, and managing clusters of indexers; and viewing the topology and performance of a deployment of the data intake and query system, among other operations. The operations performed by indexing system 820 may be referred to as “index time” operations, which are distinct from “search time” operations that are discussed further below.

Indexer 832, which may be referred to herein as a data indexing component, coordinates and performs most of the index time operations. Indexer 832 can be implemented using program code that can be executed on a computing device. The program code for indexer 832 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of indexer 832. In some implementations, indexer 832 executes on computing device 804 through which a user can access indexing system 820. In some implementations, indexer 832 executes on a different computing device.

Indexer 832 may be executing on the computing device that also provides data source 802 or may be executing on a different computing device. In implementations wherein indexer 832 is on the same computing device as data source 802, the data produced by data source 802 may be referred to as “local data.” In other implementations data source 802 is a component of a first computing device and indexer 832 executes on a second computing device that is different from the first computing device. In these implementations, the data produced by data source 802 may be referred to as “remote data.” In some implementations, the first computing device is “on-prem” and in some implementations the first computing device is “in the cloud.” In some implementations, indexer 832 executes on a computing device in the cloud and the operations of indexer 832 are provided as a service to entities that subscribe to the services provided by the data intake and query system.

For a given data produced by data source 802, indexing system 820 can be configured to use one of several methods to ingest the data into indexer 832. These methods include upload 822, monitor 824, using a forwarder 826, or using HyperText Transfer Protocol (HTTP 828) and an event collector 830. These and other methods for data ingestion may be referred to as “getting data in” (GDI) methods.

Using the upload 822 method, a user can instruct data source 802 to specify a file for uploading into indexer 832. For example, monitoring console 816 can include commands or an interface through which the user can specify where the file is located (e.g., on which computing device and/or in which directory of a file system) and the name of the file. Once uploading is initiated, indexer 832 processes the file, as discussed further below. Uploading is a manual process and occurs when instigated by a user. For automated data ingestion, the other ingestion methods are used.

The monitor 824 method enables indexing system 820 to monitor data source 802 and continuously or periodically obtain data produced by data source 802 for ingestion by indexer 832. For example, using monitoring console 816, a user can specify a file or directory for monitoring. In this example, indexing system 820 can execute a monitoring process that detects whenever data is added to the file or directory and causes the data to be sent to indexer 832. As another example, a user can specify a network port for monitoring. In this example, a monitoring process can capture data received at or transmitting from the network port and cause the data to be sent to indexer 832. In various examples, monitoring can also be configured for data sources such as operating system event logs, performance data generated by an operating system, operating system registries, operating system directory services, and other data sources.

Monitoring is available when data source 802 is local to indexer 832 (e.g., data source 802 is on the computing device where indexer 832 is executing). Other data ingestion methods, including forwarding and event collector 830, can be used for either local or remote data sources.

A forwarder 826, which may be referred to herein as a data forwarding component, is a software process that sends data from data source 802 to indexer 832. The forwarder 826 can be implemented using program code that can be executed on the computer device that provides data source 802. A user launches the program code for forwarder 826 on the computing device that provides data source 802. The user can further configure the program code, for example to specify a receiver for the data being forwarded (e.g., one or more indexers, another forwarder, and/or another recipient system), to enable or disable data forwarding, and to specify a file, directory, network events, operating system data, or other data to forward, among other operations.

Forwarder 826 can provide various capabilities. For example, forwarder 826 can send the data unprocessed or can perform minimal processing on the data. Minimal processing can include, for example, adding metadata tags to the data to identify a source, source type, and/or host, among other information, dividing the data into blocks, and/or applying a timestamp to the data. In some implementations, forwarder 826 can break the data into individual events (event generation is discussed further below) and send the events to a receiver. Other operations that forwarder 826 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

Event collector 830 provides an alternate method for obtaining data from data source 802. Event collector 830 enables data and application events to be sent to indexer 832 using HTTP 828. Event collector 830 can be implemented using program code that can be executing on a computing device. The program code may be a component of the data intake and query system or can be a standalone component that can be executed independently of the data intake and query system and operates in cooperation with the data intake and query system.

To use event collector 830, a user can, for example using monitoring console 816 or a similar interface provided by user interface system 814, enable event collector 830 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by data source 802 as an alternative method to using a username and password for authentication.

To send data to event collector 830, data source 802 is supplied with a token and can then send HTTP 828 requests to event collector 830. To send HTTP 828 requests, data source 802 can be configured to use an HTTP client and/or to use logging libraries such as those supplied by Java, JavaScript, and .NET libraries. An HTTP client enables data source 802 to send data to event collector 830 by supplying the data, and a Uniform Resource Identifier (URI) for event collector 830 to the HTTP client. The HTTP client then handles establishing a connection with event collector 830, transmitting a request containing the data, closing the connection, and receiving an acknowledgment if event collector 830 sends one. Logging libraries enable HTTP 828 requests to event collector 830 to be generated directly by the data source. For example, an application can include or link a logging library, and through functionality provided by the logging library manage establishing a connection with event collector 830, transmitting a request, and receiving an acknowledgement.

An HTTP 828 request to event collector 830 can contain a token, a channel identifier, event metadata, and/or event data. The token authenticates the request with event collector 830. The channel identifier, if available in indexing system 820, enables event collector 830 to segregate and keep separate data from different data sources. The event metadata can include one or more key-value pairs that describe data source 802 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, event collector 830 extracts events from HTTP 828 requests and sends the events to indexer 832. Event collector 830 can further be configured to send events or event data to one or more indexers. Extracting the events can include associating any metadata in a request with the event or events included in the request. In these implementations, event generation by indexer 832 (discussed further below) is bypassed, and indexer 832 moves the events directly to indexing. In some implementations, event collector 830 extracts event data from a request and outputs the event data to indexer 832, and the indexer generates events from the event data. In some implementations, event collector 830 sends an acknowledgement message to data source 802 to indicate that event collector 830 has received a particular request from data source 802, and/or to indicate to data source 802 that events in the request have been added to an index.

Indexer 832 ingests incoming data and transforms the data into searchable knowledge in the form of events. In the data intake and query system, an event is a single piece of data that represents activity of the component represented in FIG. 8 by data source 802. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, indexer 832 can include a parsing module 834 and an indexing module 836 for generating and storing the events. The parsing module 834 and indexing module 836 can be modular and pipelined, such that one component can be operating on a first set of data while the second component is simultaneously operating on a second sent of data. Additionally, indexer 832 may at any time have multiple instances of parsing module 834 and indexing module 836, with each set of instances configured to simultaneously operate on data from the same data source or from different data sources. The parsing module 834 and indexing module 836 are illustrated to facilitate discussion, with the understanding that implementations with other components are possible to achieve the same functionality.

Parsing module 834 determines information about event data, where the information can be used to identify events within the event data. For example, parsing module 834 can associate a source type with the event data. A source type identifies data source 802 and describes a possible data structure of event data produced by data source 802. For example, the source type can indicate which fields to expect in events generated at data source 802 and the keys for the values in the fields, and possibly other information such as sizes of fields, an order of the fields, a field separator, and so on. The source type of data source 802 can be specified when data source 802 is configured as a source of event data. Alternatively, parsing module 834 can determine the source type from the event data, for example from an event field or using machine learning.

Other information that parsing module 834 can determine includes timestamps. In some cases, an event includes a timestamp as a field, and the timestamp indicates a point in time when the action represented by the event occurred or was recorded by data source 802 as event data. In these cases, parsing module 834 may be able to determine from the source type associated with the event data that the timestamps can be extracted from the events themselves. In some cases, an event does not include a timestamp and parsing module 834 determines a timestamp for the event, for example from a name associated with the event data from data source 802 (e.g., a file name when the event data is in the form of a file) or a time associated with the event data (e.g., a file modification time). As another example, when parsing module 834 is not able to determine a timestamp from the event data, parsing module 834 may use the time at which it is indexing the event data. As another example, parsing module 834 can use a user-configured rule to determine the timestamps to associate with events.

Parsing module 834 can further determine event boundaries. In some cases, a single line (e.g., a sequence of characters ending with a line termination) in event data represents one event while in other cases, a single line represents multiple events. In yet other cases, one event may span multiple lines within the event data. Parsing module 834 may be able to determine event boundaries from the source type associated with the event data, for example from a data structure indicated by the source type. In some implementations, a user can configure rules parsing module 834 can use to identify event boundaries.

Parsing module 834 can further extract data from events and possibly also perform transformations on the events. For example, parsing module 834 can extract a set of fields for each event, such as a host or hostname, source or source name, and/or source type. The parsing module 834 may extract certain fields by default or based on a user configuration. Alternatively or additionally, parsing module 834 may add fields to events, such as a source type or a user-configured field. As another example of a transformation, parsing module 834 can anonymize fields in events to mask sensitive information, such as social security numbers or account numbers. Anonymizing fields can include changing or replacing values of specific fields. The parsing component 834 can further perform user-configured transformations.

The parsing module 834 outputs the results of processing incoming event data to indexing module 836, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. Indexer 832 can be configured to identify searchable segments that are parts of fields, searchable segments that are entire fields, or both. The parsing module 834 organizes the searchable segments into a lexicon or dictionary for the event data, with the lexicon including each searchable segment and a reference to the location of each occurrence of the searchable segment within the event data. As discussed further below, the search system can use the lexicon, which is stored in an index file 846, to find event data that matches a search query. In some implementations, segmentation can alternatively be performed by forwarder 826. Segmentation can also be disabled, in which case indexer 832 will not build a lexicon for the event data. When segmentation is disabled, the search system searches the event data directly.

Building index data structures generates index 838. Index 838 is a storage data structure on a storage device (e.g., a disk drive or other physical device for storing digital data). The storage device may be a component of the computing device on which indexer 832 is operating (referred to herein as local storage) or may be a component of a different computing device (referred to herein as remote storage) that the indexer 838 has access to over a network. Indexer 832 can include more than one index and can include indexes of different types. For example, indexer 832 can include event indexes, which impose minimal structure on stored data and can accommodate any type of data. As another example, indexer 832 can include metrics indexes, which use a highly structured format to handle the higher volume and lower latency demands associated with metrics data.

Indexing module 836 organizes files in index 838 in directories referred to as buckets. The files in a bucket 844 can include raw data files, index files, and possibly also other metadata files. As used herein, “raw data” means data as when the data was produced by data source 802, without alteration to the format or content. As noted previously, the parsing component 834 may add fields to event data and/or perform transformations on fields in the event data, and thus a raw data file 848 can include, in addition to or instead of raw data, what is referred to herein as enriched raw data. The raw data file 848 may be compressed to reduce disk usage. An index file 846, which may also be referred to herein as a “time-series index” or tsidx file, contains metadata that indexer 832 can use to search a corresponding raw data file 848. As noted above, the metadata in index file 846 includes a lexicon of the event data, which associates each unique keyword in the event data in the raw data file 848 with a reference to the location of event data within the raw data file 848. The keyword data in index file 846 may also be referred to as an inverted index. In various implementations, the data intake and query system can use index files for other purposes, such as to store data summarizations that can be used to accelerate searches.

A bucket 844 includes event data for a particular range of time. Indexing module 836 arranges buckets in index 838 according to the age of the buckets, such that buckets for more recent ranges of time are stored in short-term storage 840 and buckets for less recent ranges of time are stored in long-term storage 842. Short-term storage 840 may be faster to access while long-term storage 842 may be slower to access. Buckets may move from short-term storage 840 to long-term storage 842 according to a configurable data retention policy, which can indicate at what point in time a bucket is old enough to be moved.

A bucket's location in short-term storage 840 or long-term storage 842 can also be indicated by the bucket's status. As an example, a bucket's status can be “hot,” “warm,” “cold,” “frozen,” or “thawed.” In this example, hot bucket is one to which indexer 832 is writing data and the bucket becomes a warm bucket when the index 832 stops writing data to it. In this example, both hot and warm buckets reside in short-term storage 840. Continuing this example, when a warm bucket is moved to long-term storage 842, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

Indexing system 820 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can configured (e.g., three copies of each buckets must exist within the cluster), and indexers to which buckets are copied may be selected to optimize distribution of data across the cluster.

A user can view the performance of indexing system 820 through monitoring console 816 provided by user interface system 814. Using monitoring console 816, the user can configure and monitor an index cluster, and see information such as disk usage by an index, volume usage by an indexer, index and volume size over time, data age, statistics for bucket types, and bucket settings, among other information.

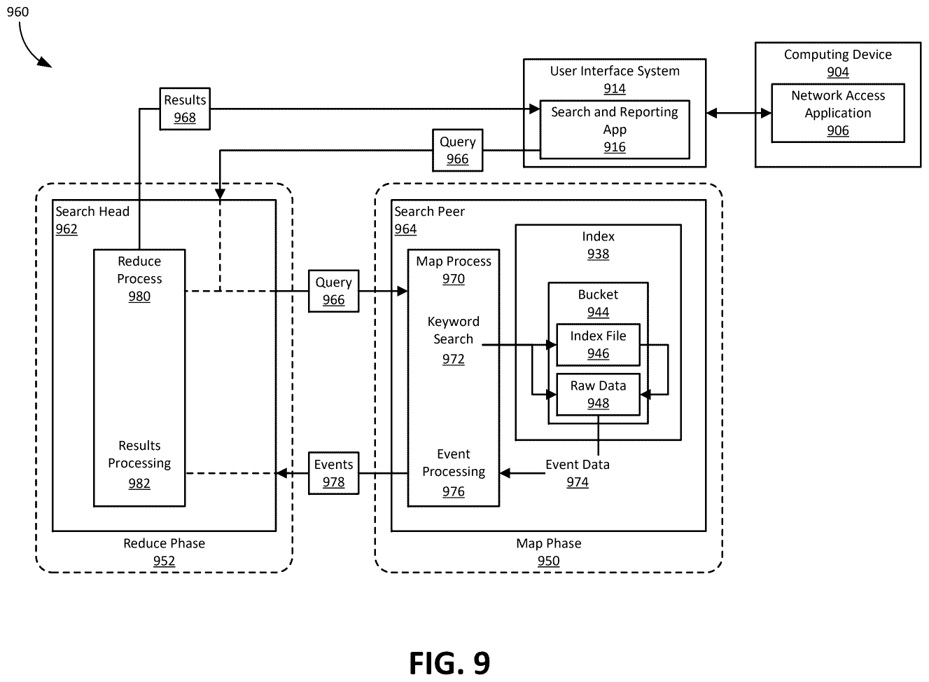

FIG. 9 is a block diagram illustrating in greater detail an example of search system 960 of a data intake and query system, such as data intake and query system 710 of FIG. 7. Search system 960 of FIG. 9 issues a query 966 to a search head 962, which sends query 966 to a search peer 964. Using a map process 970, search peer 964 searches the appropriate index 938 for events identified by query 966 and sends events 978 so identified back to search head 962. Using a reduce process 982, search head 962 processes the events 978 and produces results 968 to respond to query 966. The results 968 can provide useful insights about the data stored in index 938. These insights can aid in the administration of information technology systems, in security analysis of information technology systems, and/or in analysis of the development environment provided by information technology systems.

Query 966 that initiates a search is produced by a search and reporting app 916 that is available through user interface system 914 of the data intake and query system. Using a network access application 906 executing on a computing device 904, a user can input query 966 into a search field provided by search and reporting app 916. Alternatively or additionally, search and reporting app 916 can include pre-configured queries or stored queries that can be activated by the user. In some cases, search and reporting app 916 initiates query 966 when the user enters query 966. In these cases, query 966 maybe referred to as an “ad-hoc” query. In some cases, search and reporting app 916 initiates query 966 based on a schedule. For example, search and reporting app 916 can be configured to execute query 966 once per hour, once per day, at a specific time, on a specific date, or at some other time that can be specified by a date, time, and/or frequency. These types of queries maybe referred to as scheduled queries.

Query 966 is specified using a search processing language. The search processing language includes commands that search peer 964 will use to identify events to return in search results 968. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable query 966 to include sequential commands, where a subsequent command may operate on the results of a prior command. As an example, sequential commands may be separated in query 966 by a vertical line (“|” or “pipe”) symbol.

In addition to one or more search commands, query 966 includes a time indicator. The time indicator limits searching to events that have timestamps described by the indicator. For example, the time indicator can indicate a specific point in time (e.g., 9:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of search query 966 occurs in two broad phases: a map phase 950 and a reduce phase 952. The map phase 950 takes place across one or more search peers. In map phase 950, the search peers locate event data that matches the search terms in search query 966 and sorts the event data into field-value pairs. When map phase 950 is complete, the search peers send events that they have found to one or more search heads for the reduce phase 952. During the reduce phase 952, the search heads process the events through commands in search query 966 and aggregate the events to produce the final search results 968.

A search head, such as search head 962 illustrated in FIG. 9, is a component of search system 960 that manages searches. The search head 962, which may also be referred to herein as a search management component, can be implemented using program code that can be executed on a computing device. The program code for search head 962 can be stored on a non-transitory computer-readable medium and from this medium can be loaded or copied to the memory of a computing device. One or more hardware processors of the computing device can read the program code from the memory and execute the program code in order to implement the operations of search head 962.

Upon receiving search query 966, search head 962 directs query 966 to one or more search peers, such as search peer 964 illustrated in FIG. 9. “Search peer” is an alternate name for “indexer” and a search peer may be largely similar to the indexer described previously. The search peer 964 may be referred to as a “peer node” when search peer 964 is part of an indexer cluster. The search peer 964, which may also be referred to as a search execution component, can be implemented using program code that can be executed on a computing device. In some implementations, one set of program code implements both search head 962 and search peer 964 such that search head 962 and search peer 964 form one component. In some implementations, search head 962 is an independent piece of code that performs searching and no indexing functionality. In these implementations, search head 962 may be referred to as a dedicated search head.

Search head 962 may consider multiple criteria when determining whether to send query 966 to the particular search peer 964. For example, search system 960 may be configured to include multiple search peers that each have duplicative copies of at least some of the event data. In this example, the sending search query 966 to more than one search peer allows search system 960 to distribute the search workload across different hardware resources. As another example, search system 960 may include different search peers for different purposes (e.g., one has an index storing a first type of data or from a first data source while a second has an index storing a second type of data or from a second data source). In this example, search query 966 may specify which indexes to search, and search head 962 will send query 966 to the search peers that have those indexes.

To identify events 978 to send back to search head 962, search peer 964 performs a map process 970 to obtain event data 974 from index 938 that is maintained by search peer 964. During a first phase of the map process 970, search peer 964 identifies buckets that have events that are described by the time indicator in search query 966. As noted above, a bucket contains events whose timestamps fall within a particular range of time. For each bucket 944 whose events can be described by the time indicator, during a second phase of the map process 970, search peer 964 performs a keyword search 972 using search terms specified in search query 966. The search terms can be one or more of keywords, phrases, fields, Boolean expressions, and/or comparison expressions that in combination describe events being searched for. When segmentation is enabled at index time, search peer 964 performs keyword search 972 on the bucket's index file 946. As noted previously, the index file 946 includes a lexicon of the searchable terms in the events stored in the bucket's raw data 948 file. The keyword search 972 searches the lexicon for searchable terms that correspond to one or more of the search terms in query 966. As also noted above, the lexicon incudes, for each searchable term, a reference to each location in raw data 948 file where the searchable term can be found. Thus, when the keyword search identifies a searchable term in the index file 946 that matches query 966, search peer 964 can use the location references to extract from raw data 948 file event data 974 for each event that include the searchable term.

In cases where segmentation was disabled at index time, search peer 964 performs keyword search 972 directly on raw data 948 file. To search raw data 948, search peer 964 may identify searchable segments in events in a similar manner as when the data was indexed. Thus, depending on how search peer 964 is configured, search peer 964 may look at event fields and/or parts of event fields to determine whether an event matches query 966. Any matching events can be added to event data 974 read from raw data 948 file. Search peer 964 can further be configured to enable segmentation at search time, so that searching of index 938 causes search peer 964 to build a lexicon in the index file 946.

Event data 974 obtained from raw data 948 file includes the full text of each event found by keyword search 972. During a third phase of the map process 970, search peer 964 performs event processing 976 on event data 974, with the steps performed being determined by the configuration of search peer 964 and/or commands in search query 966. For example, search peer 964 can be configured to perform field discovery and field extraction. Field discovery is a process by which search peer 964 identifies and extracts key-value pairs from the events in event data 974. The search peer 964 can, for example, be configured to automatically extract the first 90 fields (or another number of fields) in event data 974 that can be identified as key-value pairs. As another example, search peer 964 can extract any fields explicitly mentioned in search query 966. The search peer 964 can, alternatively or additionally, be configured with particular field extractions to perform.

Other examples of steps that can be performed during event processing 976 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

Search peer 964 sends processed events 978 to search head 962, which performs a reduce process 980. Reduce process 980 potentially receives events from multiple search peers and performs various results processing 982 steps on the events. Results processing 982 steps can include, for example, aggregating the events from different search peers into a single set of events, deduplicating and aggregating fields discovered by different search peers, counting the number of events found, and sorting the events by timestamp (e.g., newest first or oldest first), among other examples. Results processing 982 can further include applying commands from search query 966 to the events. Query 966 can include, for example, commands for evaluating and/or manipulating fields (e.g., to generate new fields from existing fields or parse fields that have more than one value). As another example, query 966 can include commands for calculating statistics over the events, such as counts of the occurrences of fields, or sums, averages, ranges, and so on, of field values. As another example, query 966 can include commands for generating statistical values for purposes of generating charts of graphs of the events.

Through results processing 982, reduce process 980 produces the events found by processing search query 966, as well as some information about the events, which search head 962 outputs to search and reporting app 916 as search results 968. The search and reporting app 916 can generate visual interfaces for viewing search results 968. The search and reporting app 916 can, for example, output visual interfaces for the network access application 906 running on a computing device 904 to generate.

The visual interfaces can include various visualizations of search results 968, such as tables, line or area charts, Chloropleth maps, or single values. Search and reporting app 916 can organize the visualizations into a dashboard, where the dashboard includes a panel for each visualization. A dashboard can thus include, for example, a panel listing the raw event data for the events in search results 968, a panel listing fields extracted at index time and/or found through field discovery along with statistics for those fields, and/or a timeline chart indicating how many events occurred at specific points in time (as indicated by the timestamps associated with each event). In various implementations, search and reporting app 916 can provide one or more default dashboards. Alternatively or additionally, search and reporting app 916 can include functionality that enables a user to configure custom dashboards.

Search and reporting app 916 can also enable further investigation into the events in search results 968. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 966. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of detecting anomalies at an edge device, the method comprising receiving, at a system, sensor data captured by a set of edge devices, the set of edge devices being remote from the system, selecting, at the system and based on a query, a subset of the sensor data to be used for training a machine learning model, training, at the system, the machine learning model to detect anomalies using the subset of the sensor data, after training the machine learning model, deploying the machine learning model on the edge device, and executing the machine learning model at the edge device to detect one or more anomalies based on runtime sensor data captured at the edge device.

Example 2 is the method of example 1, wherein the runtime sensor data is captured by a sensor associated with the edge device, wherein the sensor is internal to the edge device or is external to the edge device and is communicatively coupled to the edge device via a wired or wireless connection.

Example 3 is the method of examples 1 or 2, wherein the sensor is one of: an image capture sensor, a sound sensor, a vibration sensor, an accelerometer, a gyroscope, a pressure sensor, a humidity sensor, a gas sensor, or a location sensor.

Example 4 is the method of any of examples 1-3, wherein the query is sent by a computing device to the system.

Example 5 is the method of any of examples 1-4, wherein the query specifies at least one of: a type of the sensor data, a capture time frame for the sensor data, or a sampling rate of the sensor data.

Example 6 is the method of any of examples 1-5, further comprising, after training the machine learning model, publishing the machine learning model to a list of published models, wherein the list of published models are accessible by a computing device, and receiving, from the computing device, a selection of the machine learning model from the list of published models for deployment to the edge device.

Example 7 is the method of any of examples 1-6, further comprising receiving, by the system, anomaly data including the one or more anomalies, and training a second version of the machine learning model using the one or more anomalies, and after training the second version of the machine learning model, deploying the second version of the machine learning model on the edge device.

Example 8 is a system comprising one or more processors, and a computer-readable medium comprising instructions that, when executed by the one or more processors, cause the one or more processors to perform operations comprising receiving sensor data captured by a set of edge devices, the set of edge devices being remote from the system, selecting, based on a query, a subset of the sensor data to be used for training a machine learning model, training the machine learning model to detect anomalies using the subset of the sensor data, and after training the machine learning model, deploying the machine learning model on an edge device, wherein the edge device is configured to execute the machine learning model to detect one or more anomalies based on runtime sensor data captured at the edge device.

Example 9 is the system of example 8, wherein the runtime sensor data is captured by a sensor associated with the edge device, wherein the sensor is internal to the edge device or is external to the edge device and is communicatively coupled to the edge device via a wired or wireless connection.

Example 10 is the system of examples 8 or 9, wherein the sensor is one of: an image capture sensor, a sound sensor, a vibration sensor, an accelerometer, a gyroscope, a pressure sensor, a humidity sensor, a gas sensor, or a location sensor.

Example 11 is the system of any of examples 8-10, wherein the query is sent by a computing device to the system.

Example 12 is the system of any of examples 8-11, wherein the query specifies at least one of: a type of the sensor data, a capture time frame for the sensor data, or a sampling rate of the sensor data.

Example 13 is the system of any of examples 8-12, wherein the operations further comprise, after training the machine learning model, publishing the machine learning model to a list of published models, wherein the list of published models are accessible by a computing device, and receiving, from the computing device, a selection of the machine learning model from the list of published models for deployment to the edge device.

Example 14 is the system of any of examples 8-13, further comprising receiving anomaly data including the one or more anomalies, and training a second version of the machine learning model using the one or more anomalies, and after training the second version of the machine learning model, deploying the second version of the machine learning model on the edge device.

Example 15 is a non-transitory computer-readable medium comprising instructions that, when executed by one or more processors, cause the one or more processors to perform operations comprising receiving sensor data captured by a set of edge devices, the set of edge devices being remote from a system, selecting, based on a query, a subset of the sensor data to be used for training a machine learning model, training the machine learning model to detect anomalies using the subset of the sensor data, and after training the machine learning model, deploying the machine learning model on an edge device, wherein the edge device is configured to execute the machine learning model to detect one or more anomalies based on runtime sensor data captured at the edge device.

Example 16 is the non-transitory computer-readable medium of example 15, wherein the runtime sensor data is captured by a sensor associated with the edge device, wherein the sensor is internal to the edge device or is external to the edge device and is communicatively coupled to the edge device via a wired or wireless connection.

Example 17 is the non-transitory computer-readable medium of examples 15 or 16, wherein the sensor is one of: an image capture sensor, a sound sensor, a vibration sensor, an accelerometer, a gyroscope, a pressure sensor, a humidity sensor, a gas sensor, or a location sensor.

Example 18 is the non-transitory computer-readable medium of any of examples 15-17, wherein the query specifies at least one of: a type of the sensor data, a capture time frame for the sensor data, or a sampling rate of the sensor data.

Example 19 is the non-transitory computer-readable medium of any of examples 15-18, wherein the operations further comprise, after training the machine learning model, publishing the machine learning model to a list of published models, wherein the list of published models are accessible by a computing device, and receiving, from the computing device, a selection of the machine learning model from the list of published models for deployment to the edge device.

Example 20 is the non-transitory computer-readable medium of any of examples 15-19, wherein the operations further comprise receiving anomaly data including the one or more anomalies, and training a second version of the machine learning model using the one or more anomalies, and after training the second version of the machine learning model, deploying the second version of the machine learning model on the edge device.

What is claimed is:

1. A method of detecting anomalies at an edge device, the method comprising:
receiving, at a system, sensor data captured by a set of edge devices, the set of edge devices being remote from the system;
selecting, at the system and based on a query, a subset of the sensor data to be used for training a machine learning model;
training, at the system, the machine learning model to detect anomalies using the subset of the sensor data;
after training the machine learning model, deploying the machine learning model on the edge device; and
executing the machine learning model at the edge device to detect one or more anomalies based on runtime sensor data captured at the edge device.

2. The method of claim 1, wherein the runtime sensor data is captured by a sensor associated with the edge device, wherein the sensor is internal to the edge device or is external to the edge device and is communicatively coupled to the edge device via a wired or wireless connection.

3. The method of claim 2, wherein the sensor is one of: an image capture sensor, a sound sensor, a vibration sensor, an accelerometer, a gyroscope, a pressure sensor, a humidity sensor, a gas sensor, or a location sensor.

4. The method of claim 1, wherein the query is sent by a computing device to the system.

5. The method of claim 1, wherein the query specifies at least one of: a type of the sensor data, a capture time frame for the sensor data, or a sampling rate of the sensor data.

6. The method of claim 1, further comprising:
after training the machine learning model, publishing the machine learning model to a list of published models, wherein the list of published models is accessible by a computing device; and
receiving, from the computing device, a selection of the machine learning model from the list of published models for deployment to the edge device.

7. The method of claim 1, further comprising:
receiving, by the system, anomaly data including the one or more anomalies; and
training a second version of the machine learning model using the one or more anomalies; and
after training the second version of the machine learning model, deploying the second version of the machine learning model on the edge device.

8. A system comprising:
one or more processors; and
a computer-readable medium comprising instructions that, when executed by the one or more processors, cause the one or more processors to perform operations comprising:
receiving sensor data captured by a set of edge devices, the set of edge devices being remote from the system;
selecting, based on a query, a subset of the sensor data to be used for training a machine learning model;
training the machine learning model to detect anomalies using the subset of the sensor data; and
after training the machine learning model, deploying the machine learning model on an edge device, wherein the edge device is configured to execute the machine learning model to detect one or more anomalies based on runtime sensor data captured at the edge device.

9. The system of claim 8, wherein the runtime sensor data is captured by a sensor associated with the edge device, wherein the sensor is internal to the edge device or is external to the edge device and is communicatively coupled to the edge device via a wired or wireless connection.

10. The system of claim 9, wherein the sensor is one of: an image capture sensor, a sound sensor, a vibration sensor, an accelerometer, a gyroscope, a pressure sensor, a humidity sensor, a gas sensor, or a location sensor.

11. The system of claim 8, wherein the query is sent by a computing device to the system.

12. The system of claim 8, wherein the query specifies at least one of: a type of the sensor data, a capture time frame for the sensor data, or a sampling rate of the sensor data.

13. The system of claim 8, wherein the operations further comprise:
after training the machine learning model, publishing the machine learning model to a list of published models, wherein the list of published models is accessible by a computing device; and
receiving, from the computing device, a selection of the machine learning model from the list of published models for deployment to the edge device.

14. The system of claim 8, further comprising:
receiving anomaly data including the one or more anomalies; and
training a second version of the machine learning model using the one or more anomalies; and
after training the second version of the machine learning model, deploying the second version of the machine learning model on the edge device.

15. A non-transitory computer-readable medium comprising instructions that, when executed by one or more processors, cause the one or more processors to perform operations comprising:
receiving sensor data captured by a set of edge devices, the set of edge devices being remote from a system;
selecting, based on a query, a subset of the sensor data to be used for training a machine learning model;
training the machine learning model to detect anomalies using the subset of the sensor data; and
after training the machine learning model, deploying the machine learning model on an edge device, wherein the edge device is configured to execute the machine learning model to detect one or more anomalies based on runtime sensor data captured at the edge device.

16. The non-transitory computer-readable medium of claim 15, wherein the runtime sensor data is captured by a sensor associated with the edge device, wherein the sensor is internal to the edge device or is external to the edge device and is communicatively coupled to the edge device via a wired or wireless connection.

17. The non-transitory computer-readable medium of claim 16, wherein the sensor is one of: an image capture sensor, a sound sensor, a vibration sensor, an accelerometer, a gyroscope, a pressure sensor, a humidity sensor, a gas sensor, or a location sensor.

18. The non-transitory computer-readable medium of claim 15, wherein the query specifies at least one of: a type of the sensor data, a capture time frame for the sensor data, or a sampling rate of the sensor data.

19. The non-transitory computer-readable medium of claim 15, wherein the operations further comprise:
after training the machine learning model, publishing the machine learning model to a list of published models, wherein the list of published models is accessible by a computing device; and
receiving, from the computing device, a selection of the machine learning model from the list of published models for deployment to the edge device.

20. The non-transitory computer-readable medium of claim 15, wherein the operations further comprise:
receiving anomaly data including the one or more anomalies; and
training a second version of the machine learning model using the one or more anomalies; and
after training the second version of the machine learning model, deploying the second version of the machine learning model on the edge device.
